(19) United States
(12) Patent Application Publication
(10) Pub. No.: US 2009/0179829 A1
(43) Pub. Date: Jul. 16, 2009

(54) PLASMA DISPLAY PANEL DRIVING CIRCUIT AND PLASMA DISPLAY APPARATUS

(76) Inventors: Hideki Nakata, Osaka (JP); Jumpei Hashiguchi, Kyoto (JP)

Correspondence Address: MCDERMOTT WILL & EMERY LLP, 600 13TH STREET, NW, WASHINGTON, DC, 20005-3096, US

(21) Appl. No.: 12/064,619

(22) PCT Filed: Aug. 18, 2006
(86) PCT No.: PCT/JP2006/316241

§ 371 Date: Feb. 22, 2008

(30) Foreign Application Priority Data
Aug. 23, 2005 (JP) 2005-240626

(51) Int. Cl. G09G 3/28

(52) U.S. Cl. 345/68

(57) ABSTRACT

An object of the present invention is to provide a PDP driving circuit and a plasma display apparatus each of which controls a discharge current at the time of sustain discharge by carrying out a switching operation during a power source clamping while changing a turn-on time, so as to display an image whose brightness is suppressed without deteriorating the gray scale. A PDP driving circuit (701) for driving a PDP (10) is constructed by connecting in parallel at least two switching elements (S51, S52) whose turn-on times are different from each other such that the switching elements (S51, S52) can be controlled independently as switches for applying a predetermined potential to scan electrodes and sustain electrodes.

### TECHNICAL FIELD

The present invention relates to a driving circuit of a plasma display panel for use in wall-mounted televisions and large-size monitors, and a plasma display apparatus.

### BACKGROUND ART

An AC surface discharge type plasma display panel (hereinafter abbreviated as “PDP”) that is a typical AC type panel is constructed such that: a front face plate comprised of a glass substrate formed by arranging scan electrodes and sustain electrodes which carry out surface discharge and a back face plate comprised of a glass substrate formed by arranging data electrodes are disposed in parallel with each other so as to face each other such that these electrodes are arranged in a matrix manner and a discharge space is formed in a gap; and outer peripheral portions of the front face plate and the back face plate are sealed by a sealing material, such as glass flit. Discharge cells which are partitioned by barrier ribs are formed between the substrates that are the front face plate and the back face plate, and a phosphor layer is formed in a cell space between the barrier ribs. In the PDP thus constructed, gas discharge generates ultraviolet, and the ultraviolet excites the phosphors of respective colors of red (R), green (G) and blue (B), which then emit light to carry out a color display.

FIG. 11 is a perspective view showing the construction of a PDP 10. A plurality of display electrodes are formed on a glass front face plate 20 that is a first substrate, and each display electrode is comprised of a stripe-shaped scan electrode 22 and a stripe-shaped sustain electrode 23 as a pair. A dielectric layer 24 is formed so as to cover the scan electrodes 22 and the sustain electrodes 23, and a protective layer 25 is formed on the dielectric layer 24.

A plurality of stripe-shaped data electrodes 32 covered by a dielectric layer 33 are formed on a back face plate 30 that is a second substrate such that the data electrodes 32 three-dimensionally intersect with the scan electrodes 22 and the sustain electrodes 23. A plurality of barrier ribs 34 are arranged on the dielectric layer 33 so as to be in parallel with the data electrodes 32, and a phosphor layer 35 is provided on the dielectric layer 33 between the barrier ribs 34. Each data electrode 32 is located at a position between adjacent barrier ribs 34.

The front face plate 20 and the back face plate 30 are disposed so as to face each other, while sandwiching the minute discharge space, such that the scan electrodes 22 and the sustain electrodes 23 are perpendicular to the data electrodes 32, and the outer peripheral portions of the front face plate 20 and the back face plate 30 are sealed by the sealing material, such as glass flit. In the discharge space, for example, a mixed gas of neon (Ne) and xenon (Xe) is sealed as a discharge gas. The discharge space is divided into a plurality of sections by the barrier ribs 34, and the phosphor layers 35 each of which emits light of red (R), green (G) or blue (B) are sequentially disposed in the sections, respectively. Moreover, discharge cells are formed at portions where the scan electrodes 22 intersect with the data electrodes 32 and portions where the sustain electrodes 23 intersect with the data electrodes 32, and one pixel is formed by three adjacent discharge cells in which the phosphor layers 35 that emit light of the respective colors are formed. An area where the discharge cells constituting the pixels are formed is an image display area, and an area around the image display area is a non-display area which displays no image, such as an area where the glass flit is formed.

FIG. 12 is a diagram showing the arrangement of electrodes of the PDP 10. Scan electrodes SC₁ to SCₙ (scan electrodes 22 in FIG. 11) in n rows and sustain electrodes SU₁ to SUₙ (sustain electrodes 23 in FIG. 11) in n rows are arranged alternately so as to extend in a row direction, and data electrodes D₁ to Dₘ (data electrodes 32 in FIG. 11) in m columns are arranged so as to extend in a column direction. Discharge cells C_{i,j} each including a pair of the scan electrode SCᵢ and the sustain electrode SUᵢ (i=1 to n) and one data electrode Dⱼ (j=1 to m) are formed in the discharge space, and the total number of the discharge cells C is obtained by m×n.

In the PDP 10 thus constructed, gas discharge generates ultraviolet, and the ultraviolet excites the phosphors of respective colors of R, G and B, which then emit light to carry out a color display. Moreover, the PDP 10 divides one field period into a plurality of sub-fields and carries out a gray scale display by being driven in accordance with combinations of the sub-fields in which light is emitted. Each sub-field includes a reset period, an address period and a sustain period. To display image data, different signal waveforms among the reset period, the address period and the sustain period are applied to respective electrodes.

FIG. 13 is a diagram showing drive voltage waveforms applied to respective electrodes of the PDP 10. As shown in FIG. 13, each sub-field includes: the reset period in which the inside of the discharge cell C of the PDP 10 is charged to realize address discharge; the address period which is a period after the reset period, for generating the address discharge in the discharge cells to be turned on; and the sustain period which is a period after the address period, for turning on the discharge cells C in which the address discharge is generated. Substantially same operations are carried out in respective sub-fields except that the number of sustain pulses in the sustain period is changed to change the weight of a light-emitting period, and operation principles in respective sub-fields are also substantially the same as each other. Therefore, only operations in one sub-field will be explained herein.

First, in the reset period, for example, a positive pulse voltage is applied to all the scan electrodes SC₁ to SCₙ to accumulate required wall charge on the protective layer 25 formed on the dielectric layer 24 which covers the scan electrodes SC₁ to SCₙ and the sustain electrodes SU₁ to SUₙ and to accumulate required wall charge on the phosphor layer 35. In addition, in the reset period, a priming (priming for discharge, that is, excited particle) for stably generating the address discharge while minimizing discharge time lag is generated.

Specifically, in the first half of the reset period, the data electrodes D₁ to Dₘ and the sustain electrodes SU₁ to SUₙ are held at 0 (V), and a ramp waveform voltage moderately rising from a voltage Vᵢ₁ which is not more than a discharge start voltage based on the data electrodes D₁ to Dₘ toward a voltage Vᵢ₂ which exceeds the discharge start voltage is applied to the scan electrodes SC₁ to SCₙ. While the ramp waveform voltage is rising, a first weak reset discharge takes place between the scan electrodes SC₁ to SCₙ and the data electrodes D₁ to Dₘ and between the sustain electrodes SU₁ to SUₙ and the scan electrodes SC₁ to SCₙ. Thus, a negative wall voltage is accumulated on an upper portion of each of the scan electrodes SC₁ to SCₙ whereas a positive wall voltage is accumulated on an upper portion of each of the data electrodes D₁ to Dₘ and an upper portion of each of the sustain electrodes SU₁ to SUₙ. Here, the wall voltage on the upper portion of each electrode is a voltage generated by the wall charge accumulated on the dielectric layer which covers the electrode.

In the second half of the reset period, the sustain electrodes SU₁ to SUₙ are held at a positive voltage Ve, and a ramp waveform voltage falling from a voltage Vᵢ₃ which is not more than the discharge start voltage based on the sustain electrodes SU₁ to SUₙ to a voltage Vᵢ₄ which exceeds the discharge start voltage is applied to the scan electrodes SC₁ to SCₙ. While the ramp waveform voltage is falling, a second weak reset discharge takes place between the scan electrodes SC₁ to SCₙ and the data electrodes D₁ to Dₘ and between the sustain electrodes SU₁ to SUₙ and the scan electrodes SC₁ to SCₙ. Then, the negative wall voltage on the upper portion of each of the scan electrodes SC₁ to SCₙ and the positive wall voltage on the upper portion of each of the sustain electrodes SU₁ to SUₙ are weakened, so that the positive wall voltage on the upper portion of each of the data electrodes D₁ to Dₘ is adjusted to a value suitable for an address operation. Thus, a reset operation is terminated (hereinafter, the drive voltage waveform applied to each electrode in the reset period is referred to as “reset waveform”).

Next, in the address period, a negative scan pulse is sequentially applied to all the scan electrodes SC₁ to SCₙ to carry out scanning. While scanning the scan electrodes SC₁ to SCₙ, a positive address pulse voltage is applied to the data electrodes D₁ to Dₘ based on display data. Thus, the address discharge is generated between the scan electrodes SC₁ to SCₙ and the data electrodes D₁ to Dₘ, and the wall charge is formed on the surface of the protective layer 25 on the scan electrodes SC₁ to SCₙ.

Specifically, in the address period, the scan electrodes SC₁ to SCₙ are once held at a voltage Vscn. Next, in the address operation of the discharge cells C_{p,1} to C_{p,m} (p is an integer of 1 to n), a scan pulse voltage Vad is applied to a scan electrode SCₚ whereas a positive address pulse voltage Vd is applied to a data electrode D_{q} (D_{q} is a data electrode selected from D₁ to Dₘ based on a video signal) corresponding to a video signal to be displayed in the p-th row of the data electrodes D₁ to Dₘ. Thus, the address discharge is generated at a discharge cell C_{p,q} corresponding to an intersection of the data electrode D_{q} to which the address pulse voltage is applied and the scan electrode SCₚ to which the scan pulse voltage is applied. The address operation terminates after the positive voltage is accumulated at an upper portion of the scan electrode SCₚ of the discharge cell C_{p,q} and the negative voltage is accumulated at an upper portion of the sustain electrode SUₚ by the address discharge. After the address operation is carried out until the discharge cell C_{n,q} of the n-th line, the address operation terminates.

In a certain period of the subsequent sustain period, a voltage sufficient to maintain discharge is applied between the scan electrodes SC₁ to SCₙ and the sustain electrodes SU₁ to SUₙ. Thus, discharge plasma is generated between the scan electrodes SC₁ to SCₙ and the sustain electrodes SU₁ to SUₙ, and the phosphor layer 35 is excited and emits light in a certain period. Here, discharge does not take place in the discharge space to which the address pulse voltage is not applied in the address period, so that the phosphor layer 35 is not excited or does not emit light.

Specifically, in the sustain period, after the scan electrodes SC₁ to SCₙ return to 0 (V) once, a positive sustain pulse voltage Vsus is applied to the scan electrodes SC₁ to SCₙ. Then, the sustain electrodes SU₁ to SUₙ returns to 0 (V). Here, a voltage between the upper portion of the scan electrode SCₚ and the upper portion of the sustain electrode SUₚ at the discharge cell C_{p,q} in which the address discharge took place becomes larger than the discharge start voltage since the wall voltage accumulated at the upper portion of the scan electrode SCₚ and the upper portion of the sustain electrode SUₚ in the address period is added to the positive sustain pulse voltage Vsus. Thus, a first sustain discharge is generated. Then, at the discharge cell C_{p,q} which has generated the sustain discharge, the negative voltage is accumulate at the upper portion of the scan electrode SCₚ and the positive voltage is accumulated at the upper portion of the sustain electrode SUₚ such that a potential difference between the scan electrode SCₚ and the sustain electrode SUₚ at the time of generation of the sustain discharge is canceled. Thus, the first sustain discharge terminates. After the first sustain discharge, the positive sustain pulse voltage Vsus is applied to the sustain electrodes SU₁ to SUₙ. Then, the scan electrodes SC₁ to SCₙ return to 0 (V). Here, a voltage between the upper portion of the scan electrode SCₚ and the upper portion of the sustain electrode SUₚ at the discharge cell C_{p,q} in which the first sustain discharge took place becomes larger than the discharge start voltage since the wall voltage accumulated at the upper portion of the scan electrode SCₚ and the upper portion of the sustain electrode SUₚ in the first sustain discharge is added to the positive sustain pulse voltage Vsus. Thus, a second sustain discharge is generated. After this, by alternately applying the sustain pulse to the scan electrodes SC₁ to SCₙ and the sustain electrodes SU₁ to SUₙ, the sustain discharge is continuously carried out with respect to the discharge cell C_{p,q} which has generated the address discharge, and the number of sustain discharge corresponds to the number of sustain pulses.

FIG. 14 is a block diagram showing the electrical configuration of a plasma display apparatus into which the PDP 10 is incorporated. A plasma display apparatus 600 shown in FIG. 14 includes an AD converter 1, a video signal processing circuit 2, a sub-field processing circuit 3, a data electrode driving circuit 4, a scan electrode driving circuit 5, a sustain electrode driving circuit 6 and the PDP 10.

The AD converter 1 converts an input analog video signal into a digital video signal. The video signal processing circuit 2 converts an input digital video signal of one field into sub-field data which controls respective sub-fields such that the PDP 10 carries out luminescent display in accordance with combinations of a plurality of sub-fields which are different from each other in the weight of the light-emitting period.

The sub-field processing circuit 3 generates a data electrode driving circuit control signal, a scan electrode driving circuit control signal and a sustain electrode driving circuit control signal from the sub-field data generated by the video signal processing circuit 2, and outputs those signals to the data electrode driving circuit 4, the scan electrode driving circuit 5 and the sustain electrode driving circuit 6, respectively.

As described above, in the PDP 10, the scan electrodes SC₁ to SCₙ (scan electrodes 22 in FIG. 11) in n rows and the sustain electrodes SU₁ to SUₙ (sustain electrodes 23 in FIG. 11) in n rows are alternately arranged so as to extend in the row direction, and the data electrodes D₁ to Dₘ (data electrodes 32 in FIG. 11) in m columns are arranged so as to extend in the column direction. Moreover, the discharge cells C_{i,j} each including a pair of the scan electrode SCᵢ and the sustain electrode SUⁱ (i=1 to n) and one data electrode Dⱼ (j=1 to m) are formed in the discharge space, and the number of the discharge cells C_{i,j} is obtained by m×n. Further, three discharge cells which emit light of red, green and blue, respectively, constitute one pixel.

The data electrode driving circuit 4 independently drives respective data electrodes Dⱼ based on the data electrode driving circuit control signal.

The scan electrode driving circuit 5 includes therein a sustain pulse generating circuit 51 for generating the sustain pulse applied to the scan electrodes SC₁ to SCₙ in the sustain period, and can independently drive respective scan electrodes SC₁ to SCₙ. Thus, the scan electrode driving circuit 5 independently drives respective scan electrodes SC₁ to SCₙ based on the scan electrode driving circuit control signal.

The sustain electrode driving circuit 6 includes therein a sustain pulse generating circuit 61 for generating the sustain pulse applied to the sustain electrodes SU₁ to SUₙ in the sustain period, and can drive all the sustain electrodes SU₁ to SUₙ of the PDP 10 together. Thus, the sustain electrode driving circuit 6 drives the sustain electrodes SU₁ to SUₙ based on the sustain electrode driving circuit control signal.

To reduce the power consumption of the plasma display apparatus 600, various power consumption reduction techniques have been proposed.

Disclosed as one of the power consumption reduction techniques is so-called electric power recovering circuit (see Patent Document 1 for example) in which focusing attention on the PDP 10 being a capacitive load, a resonance circuit including an inductor as a component causes a LC resonance of the inductor and the capacitive load of the PDP 10, electric power stored in the capacitive load of the PDP 10 is recovered in an electric power recovering condenser, and the recovered electric power is reused to drive the PDP 10.

In this technique, the electric power consumption in the sustain period is reduced by, for example, reusing the electric power recovered from the PDP 10 to apply the sustain pulse voltage to the scan electrodes SC₁ to SCₙ and the sustain electrodes SU₁ to SUₙ in the sustain period to reduce. Thus, it is possible to realize the power consumption reduction.

To be specific, the sustain pulse generating circuit 51 is constructed to include a resonance circuit having an inductor, that is, an electric power recovering circuit, recover the electric power stored in the capacitive load (capacitive load generated in the scan electrodes SC₁ to SCₙ) of the PDP 10, and reuse the recovered electric power as a driving electric power for driving the scan electrodes SC₁ to SCₙ. Thus, the sustain pulse generating circuit 51 reduces the power consumption. Moreover, the sustain pulse generating circuit 61 is constructed to include an electric power recovering circuit, recover the electric power stored in the capacitive load (capacitive load generated in the sustain electrodes SU₁ to SUₙ) of the PDP 10, and reuse the recovered electric power as a driving electric power for driving the sustain electrodes SU₁ to SUₙ. Thus, the sustain pulse generating circuit 61 reduces the power consumption. This construction will be explained with reference to the drawings.

FIG. 15 is a circuit diagram of the scan electrode driving circuit 5 including an electric power recovering circuit, and the sustain pulse generating circuit 61 which includes an electric power recovering circuit and is included in the sustain electrode driving circuit 6.

The scan electrode driving circuit 5 includes the sustain pulse generating circuit 51, a reset waveform generating circuit 52 and a scan pulse generating circuit 53.

The sustain pulse generating circuit 51 includes a constant-voltage power source V1 of the voltage value Vsus, an electric power recovering section having a coil L1, a recovering condenser C1, switching elements S1 and S2 and back flow preventing diodes D1 and D2, and a voltage clamp section having switching elements S5 and S6. The electric power recovering section uses the coil L1 that is an inductance element to cause the LC resonance of the capacitive load (capacitive load generated in the scan electrodes SC₁ to SCₙ) of the PDP 10 and the coil L1. Thus, the electric power recovering section recovers and supplies the electric power. At the time of recovering the electric power, the electric power stored in the capacitive load generated in the scan electrodes SC₁ to SCₙ moves through the current back flow preventing diode D2 and the switching element S2 to the recovering condenser C1. At the time of supplying the electric power, the electric power stored in the recovering condenser C1 moves through the switching element S1 and the back flow preventing diode D1 to the PDP 10 (scan electrodes SC₁ to SCₙ). Thus, the driving of the scan electrodes SC₁ to SCₙ in the sustain period is carried out. Therefore, the electric power recovering section drives the scan electrodes SC₁ to SCₙ in the sustain period by the LC resonance without the electric power supplied from the constant-voltage power source V1. Therefore, the power consumption is theoretically 0.

Meanwhile, the voltage clamp section supplies the electric power from the constant-voltage power source V1 of the voltage value Vsus through the switching element S5 to the scan electrodes SC₁ to SCₙ so as to clamp the scan electrodes SC₁ to SCₙ to the voltage value Vsus and clamp the scan electrodes SC₁ to SCₙ to a ground potential through the switching element S6. Thus, the voltage clamp section drives the scan electrodes SC₁ to SCₙ. Therefore, at the time of driving the scan electrodes SC₁ to SCₙ by the voltage clamp section, the impedance of the power supply is very low, and the rising and falling of the sustain pulse becomes steep, however, the power is consumed since the electric power is supplied from the power source.

Thus, the sustain pulse generating circuit 51 switches between the electric power recovering section and the voltage clamp section by the switching of the switching elements S1, S2, S5 and S6 so as to generate the sustain pulse applied to the scan electrodes SC₁ to SCₙ. Here, in the sustain pulse generating circuit 51 utilizing the LC resonance, the electric power recovering section carries out the power supply until the sustain pulse voltage becomes a maximal value, and then the electric power recovering section is switched to the voltage clamp section. Thus, it is possible to carry out the driving maximally utilizing the electric power recovering section whose power consumption is theoretically 0. Moreover, it is possible to reduce the power consumption of the scan electrode driving circuit 5.

The switching elements S1, S2, S5 and S6 are constituted of generally known elements such as MOSFETs (MOS field-effect transistors) which carry out switching operations. In the MOSFET, a parasitic diode (diode formed by being parasitic on the structure of the MOSFET), generally called a body diode, is formed in parallel with a portion carrying out the switching operation, and an anode and a cathode are formed opposite to each other with respect to the portion carrying out the switching operation (hereinafter, such structure is referred to as “antiparallel”). Therefore, the switching element can apply a forward current to the body diode even if the switching operation is in a cutoff state.

The reset waveform generating circuit 52 includes switching elements S21 and S22 constituted of generally known elements such as MOSFETs which carry out the switching operation, a constant-voltage power source V2 of a voltage value Vset, and a constant-voltage power source V3 of a negative voltage value Vad. The reset waveform generating circuit 52 supplies the electric power from the constant-voltage power source V2 through the switching element S21 to the scan electrodes SC₁ to SCₙ and supplies the electric power of a negative potential from the constant-voltage power source V3 through the switching element S22 to the scan electrodes SC₁ to SCₙ, so as to generate the reset waveform. Moreover, the switching element S21 is disposed such that when the switching element S21 is cut off (hereinafter, cutting off the switching element is abbreviated as “OFF”), current does not flow from the constant-voltage power source V2 through the body diode to a main discharge path (path to which the sustain pulse generating circuit 51, the reset waveform generating circuit 52 and the scan pulse generating circuit 53 are commonly connected and through which the electric power to be supplied to the scan electrodes SC₁ to SCₙ and the recovered electric power from the scan electrodes SC₁ to SCₙ flow). Further, the switching element S22 is disposed such that when the switching element S22 is OFF, current does not flow from the main discharge path through the body diode to the constant-voltage power source V3.

Thus, the reset waveform generating circuit 52 generates the above-described reset waveform, generates, in the first half of the reset period, a ramp waveform moderately rising from the voltage Vᵢ₁ that is not more than the discharge start voltage with respect to the data electrodes D₁ to Dₘ to the voltage Vᵢ₂ that exceeds the discharge start voltage, that is, the voltage value Vset, and generates, in the second half of the reset period, a ramp waveform moderately falling from the voltage Vᵢ₃ that is not more than the discharge start voltage with respect to the sustain electrodes SU₁ to SUₙ to the voltage Vᵢ₄ that exceeds the discharge start voltage, that is, the voltage value Vad.

The scan pulse generating circuit 53 includes switching elements S31 and S32 constituted of generally known elements such as MOSFETs which carry out the switching operation, a constant-voltage power source V4 of a voltage value Vscn, a back flow preventing diode D31 which prevents current from flowing into the constant-voltage power source V4, a condenser C31, and an IC 31 that is a Scan IC which has two input ports and generates a scan pulse waveform by outputting one of the electric powers inputted to these two input ports by the switching.

In the address period, scanning is carried out by sequentially applying the negative scan pulse to all the scan electrodes SC₁ to SCₙ. Therefore, in the address period, the switching element S31 is caused to be conductive (hereinafter, causing the switching element to be conductive is abbreviated as “ON”), and the electric power of the voltage value Vscn supplied from the constant-voltage power source V4 through the back flow preventing diode D31 and the switching element S31 is supplied to one of the input ports of the IC 31. Moreover, the switching element S22 of the reset waveform generating circuit 52 is ON, and the electric power of the negative voltage value Vad from the constant-voltage power source V3 through the switching element S22 is supplied to the other input port of the IC 31. Then, the IC 31 selects one of the electric power supplied from the constant-voltage power source V4 and the electric power supplied from the constant-voltage power source V3, and the selected electric power is supplied to the scan electrodes SC₁ to SCₙ. To be specific, the IC 31 carries out the switching operation such that the electric power supplied from the constant-voltage power source V3 is supplied to the scan electrodes SC₁ to SCₙ at the timing of application of the negative scan pulse, and the electric power supplied from the constant-voltage power source V4 is supplied to the scan electrodes SC₁ to SCₙ at the timings other than the above timing.

Note that the switching element S32 is OFF in the address period, and is ON in the reset period and the sustain period. This is to supply the same electric power to two input ports of the IC 31 by turning ON the switching element S32 and to supply the same electric power to the scan electrodes SC₁ to SCₙ regardless of the switching state of the IC 31.

Note that the switching of the switching elements S1, S2, S5, S6, S21, S22, S31 and S32 and the IC 31 are controlled based on a sub-field control signal generated in the sub-field processing circuit 3.

In order to electrically isolate the sustain pulse generating circuit 51 from the reset waveform generating circuit 52, switching elements S9 and S10 are disposed in series on the main discharge path extending between the sustain pulse generating circuit 51 and the reset waveform generating circuit 52 such that their body diodes are disposed opposite to each other (hereinafter serial connection in which diodes are disposed opposite to each other is referred to as “back-to-back connection”). With this construction, by turning OFF the switching elements S9 and S10 at the same time, both the current flowing from the sustain pulse generating circuit 51 to the reset waveform generating circuit 52 and the current flowing from the reset waveform generating circuit 52 to the sustain pulse generating circuit 51 can be cut off. Thus, the sustain pulse generating circuit 51 can be electrically isolated from the reset waveform generating circuit 52.

This is to, at the time of the power supply from the constant-voltage power source V2 of the reset waveform generating circuit 52, prevent the affection of the constant-voltage power source V1 of the sustain pulse generating circuit 51 which is lower in potential than the constant-voltage power source V2, and at the time of the power supply from the constant-voltage power source V3 of the negative voltage in the reset waveform generating circuit 52, prevent the affection of a higher potential than the negative voltage, that is, the ground potential (hereinafter, abbreviated as “GND”) of the sustain pulse generating circuit 51.

At the time of the power supply by the constant-voltage power source V2, current may flow from the constant-voltage power source V2 of the voltage value Vset through the main discharge path to the constant-voltage power source V1 which is lower in potential than the constant-voltage power source V2. In such a case, the potential of the main discharge path becomes lower than the potential Vset of the constant-voltage power source V2, so that it becomes difficult to generate an intended drive voltage waveform. Moreover, at the time of the power supply by the constant-voltage power source V3 of the negative voltage value Vad, current may flow from the GND that is higher in potential than the constant-voltage power source V3 through the main discharge path to the constant-voltage power source V3. In such a case, the potential of the main discharge path becomes higher than the negative voltage value Vad of the constant-voltage power source V3, so that it becomes difficult to generate the intended drive voltage waveform.

However, by turning OFF the switching elements S9 and S10 in the reset period in which the reset waveform generating circuit 52 drives the scan electrodes SC₁ to SCₙ, the sustain pulse generating circuit 51 can be electrically isolated from the reset waveform generating circuit 52, so that the flow of the above current can be cut off. Therefore, in the period in which the sustain pulse generating circuit 51 drives the scan electrodes SC₁ to SCₙ, the switching elements S9 and S10 are turned ON, so that the sustain pulse generating circuit 51 is electrically connected to the main discharge path, and in a period, such as the reset period, other than the above period, the switching elements S9 and S10 are turned OFF, so that the sustain pulse generating circuit 51 is electrically isolated from the main discharge path.

In the period in which the sustain pulse generating circuit 51 drives the scan electrodes SC₁ to SCₙ, the constant-voltage power source V2 which is higher in potential than the constant-voltage power source V1 and the constant-voltage power source V3 which is lower in potential than the GND need to be electrically isolated from the main discharge path. This can be realized by turning OFF the switching elements S21 and S22. This is because the switching element S21 is disposed in such a direction that the body diode of the switching element S21 cuts off the current flowing from the constant-voltage power source V2 to the main discharge path, and the switching element S22 is disposed in such a direction that the body diode of the switching element S22 cuts off the current flowing from the main discharge path to the constant-voltage power source V3.

The sustain pulse generating circuit 61 of the sustain electrode driving circuit 6 includes a constant-voltage power source V5 of the voltage value Vsus, an electric power recovering section having a coil L2, a recovering condenser C2, switching elements S3 and S4 and back flow preventing diodes D3 and D4, and a voltage clamp section having switching elements S7 and S8. The sustain pulse generating circuit 61 is constructed to recover the electric power in the recovering condenser C2 by causing the LC resonance of the capacitive load (capacitive load generated in the sustain electrodes SU₁ to SUₙ) of the PDP 10 and the coil L2. Operations of the sustain pulse generating circuit 61 are the same as those of the sustain pulse generating circuit 51, so that explanations thereof are omitted here.

Meanwhile, in the PDP 10, it is important to clearly display images as well as to reduce the power consumption. Various techniques of brightly displaying images to facilitate visualization of the images have been proposed.

Disclosed as one of the techniques of brightly displaying images is a technique of controlling the number of sustain pulses in the sustain period. This technique applies such a principle that the brightness of the discharge cell appears to be increased as the number of times of light emission in the sustain period increases. For example, one field is constituted of eight sub-fields that are the first sub-field to the eighth sub-field (hereinafter, the first sub-field is abbreviated as “SF1”, the second sub-field is abbreviated as “SF2”, etc.). In a case where the number of sustain pulses of the SF1 is 1, the number of sustain pulses of the SF2 is 2, and the numbers of sustain pulses of the SF3 to the SF8 are 4, 8, 16, 32, 64 and 128, respectively, the number of times of light emission in the sustain period is controlled by changing the number of sustain pulses in the sub-field among once, twice, three times and four times (hereinafter, the magnification of the number of sustain pulses is abbreviated as “brightness magnification”), such as a twice mode in which the numbers of sustain pulses of the SF1 to the SF8 are double, that is, 2, 4, 8, 16, 32, 64, 128 and 256, respectively, a three times mode in which the numbers of sustain pulses of the SF1 to the SF8 are three times, respectively, and a four times mode in which the numbers of sustain pulses of the SF1 to the SF8 are four times, respectively. Thus, the brightness of the screen image can be adjusted. Using this technique, it is possible to brightly display a dark image by detecting average brightness of the image (APL: Average Picture Level), switching the brightness magnification based on the detected APL, and increasing the brightness magnification when the APL is low (see Patent Document 2 for example).

Alternatively, disclosed is, for example, a technique which applies such a phenomenon that the sustain discharge is strongly generated by making the inclination of the sustain pulse waveform steep, thus increasing the brightness. In this technique, the brightness is improved by detecting the APL, controlling a driving time of the electric power recovering section based on the detected APL, and generating the strong sustain discharge by making the inclination of the sustain pulse waveform steep when the APL of the image is low (see Patent Document 3 for example).

Patent Document 1: Japanese Examined Patent Application Publication No. 7-109542

Patent Document 2: Japanese Unexamined Patent Application Publication No. 8-286636

Patent Document 3: Japanese Unexamined Patent Application Publication No. 2001-184024

### DISCLOSURE OF THE INVENTION

### Problems to be Solved by the Invention

The above-described techniques can display dynamic images in such a manner that by, for example, increasing the number of sustain pulses in the sustain period or generating the strong sustain discharge by making the sustain pulse waveform steep, the maximal value (hereinafter referred to as “peak brightness”) of the brightness of the discharge cell is increased, and the discharge cell emits bright light.

In accordance with the above-described techniques, it is possible to brightly display images by causing the discharge cell to emit bright light. However, since the discharge cell emits bright light, a dark region, etc. in the image is also displayed brightly. As a result, a whitish image whose black is not sharp, that is, so called an image whose black is less deep is displayed in some cases. Especially, if the black is less deep in the case of frequently displaying dark images, such as a case of seeing a movie including many wholly dark scenes, the quality of the images may deteriorate.

Alternatively, the displayed images may appear to be excessively bright in a case where the circumstance of seeing the plasma display apparatus 600 and the brightness of the displayed image are unbalanced, such as a case where the images are displayed unnecessarily brightly when seeing the plasma display apparatus 600 in a dark circumstance.

In such a case, in accordance with the above-described conventional techniques, the brightness is adjusted by signal processing, such as so-called contrast control, so as to display images whose black is sharp or images which does not appear to be excessively bright. For example, in the plasma display apparatus 600 which carries out image display using 1,024 tones from a brightness value 0 to 1,023, in a case where the peak brightness is set to the brightness value 511 that is half the maximal brightness value 1,023 by the contrast control, it is possible to display images whose contrast is half, that is, whose brightness is half.

However, in accordance with the brightness control by the contrast control, etc., by setting the peak brightness to the brightness value 511 that is half the maximal brightness value 1,023, the image display needs to be carried out by 512 tones from the brightness value 0 to 511, thereby deteriorating the gray scale of the displayed image.

The present invention was made to solve the above problems, and an object of the present invention is to provide a PDP driving circuit and a plasma display apparatus, the PDP driving circuit including an electric power recovering circuit which recovers electric power by the LC resonance, the PDP driving circuit and the plasma display apparatus being capable of displaying images whose brightness is suppressed without deteriorating the gray scale by controlling discharge currents flowing through a discharge path at the time of sustain discharge by carrying out a switching operation at the time of a power source clamping while changing a turn-on time.

### Means for Solving the Problems

To achieve the above object, a PDP driving circuit of the present invention drives a plasma display panel including a plurality of scan electrodes and sustain electrodes constituting pairs of display electrodes, wherein as switches for applying a predetermined potential to the scan electrodes and the sustain electrodes, at least two switching elements whose turn-on times are different from each other are connected to each other in parallel, and these switching elements are able to be controlled independently.

In accordance with this construction, it is possible to apply a voltage while switching between at least two switching elements whose turn-on times are different from each other. For example, by applying a voltage by a switching element whose turn-on time is comparatively long, it is possible to limit a discharge current flowing at the time of sustain discharge and display an image whose brightness is suppressed without deteriorating the gray scale.

Moreover, the plasma display panel driving circuit may drive the plasma display panel by applying, to the scan electrodes and the sustain electrodes of the PDP, voltages of driving waveforms different for each of periods in a sub-field including a reset period in which insides of discharge cells of the plasma display panel are charged to realize address discharge, an address period which is a period after the reset period and in which the address discharge is generated in the discharge cells to be turned on, and a sustain period which is a period after the address period and in which the discharge cells in which the address discharge is generated are turned on, the plasma display panel driving circuit including: a scan electrode driving circuit connected to the scan electrodes; and a sustain electrode driving circuit connected to the sustain electrodes, wherein: the scan electrode driving circuit or the sustain electrode driving circuit may include a sustain pulse generating circuit which is constituted of an electric power recovering section and a clamp section to generate a sustain pulse applied to the scan electrodes or the sustain electrodes of the PDP in respective sustain periods of a plurality of sub-fields constituting one field, the electric power recovering section recovering, in a recovering condenser by a LC resonance, electric power accumulated in capacitive load of the scan electrodes or the sustain electrodes of the plasma display panel and reusing the recovered electric power for driving the plasma display panel, the clamp section applying a power source potential or a ground potential to the scan electrodes or the sustain electrodes of the plasma display panel; and as a power source clamp switch of the clamp section which applies the power source potential to the scan electrodes or the sustain electrodes, at least two switching elements whose turn-on times are different from each other may be connected to each other in parallel, and the switching elements may be controlled independently.

In accordance with this construction, it is possible to apply a power source potential while switching between at least two switching elements whose turn-on times are different from each other. For example, by applying the power source potential by a switching element whose turn-on time is comparatively long, it is possible to limit a discharge current flowing at the time of sustain discharge and display an image whose brightness is suppressed without deteriorating the gray scale.

Moreover, the at least two switching elements may be MOSFETs whose turn-on times are different from each other. In accordance with this construction, it is possible to easily realize a combination of switching elements whose turn-on times are different from each other. For example, by applying the power source potential by a MOSFET whose turn-on time is comparatively long, it is possible to limit a discharge current flowing at the time of sustain discharge, and display an image whose brightness is suppressed without deteriorating the gray scale.

Moreover, the at least two switching elements may include a MOSFET made of silicone carbide and a MOSFET made of silicone. In accordance with this construction, since the MOSFET made of silicone carbide has a comparatively short turn-on time, and the MOSFET made of silicone has a comparatively long turn-on time, it is possible to easily construct a power source clamp switch capable of switching the turn-on time.

Moreover, the at least two switching elements may include a MOSFET and an IGBT whose turn-on times are different from each other. In accordance with this construction, since the MOSFET has a comparatively short turn-on time, and the IGBT has a comparatively long turn-on time, it is possible to easily realize a combination of switching elements whose turn-on times are different from each other. For example, it is possible to limit a discharge current flowing at the time of sustain discharge by carrying out the power source clamping by the IGBT whose turn-on time is comparatively long, and display an image whose brightness is suppressed without deteriorating the gray scale.

Moreover, the MOSFET may be a MOSFET made of silicone carbide. In accordance with this construction, since the MOSFET made of silicone carbide has a comparatively short turn-on time, and the IGBT has a comparatively long turn-on time, it is possible to easily construct a power source clamp switch capable of switching the turn-on time.

Moreover, by constructing the power source clamp switch constituted of at least two switching elements whose turn-on times are substantially the same as each other instead of at least two switching elements whose turn-on times are different from each other, and by applying a signal, for causing the switching elements to be conductive, to the switching elements through respective resistors having different resistance values, the apparent turn-on times of these switching elements may be made different from each other. In accordance with this construction, even in the case of using the switching elements whose turn-on times are substantially the same as each other, the apparent turn-on times of the switching elements can be made different from each other by applying the signal, for causing the switching elements to be conductive, through respective resistors having different resistance values. For example, the apparent turn-on time can be made comparatively long by applying the power source potential by applying the signal, for causing the switching element to be conductive, through a resistor having a comparatively large resistance value. Thus, it is possible to limit the discharge current flowing at the time of sustain discharge, and display an image whose brightness is suppressed without deteriorating the gray scale.

Moreover, by constructing each of the gate driving circuits of the switching elements which is constituted of at least one resistor and at least one condenser, and by setting the resistance value of the resistor or the capacitance value of the condenser to be different between the switching elements, the apparent turn-on times of the switching elements may be made different from each other. In accordance with this construction, even in the case of using the switching elements whose turn-on times are substantially the same as each other, the apparent turn-on times of the switching elements can be made different from each other by applying the signal, for causing the switching elements to be conductive, through respective resistors having different resistance values or through condensers having different capacitances. For example, the apparent turn-on time can be made comparatively long by applying the power source potential by applying the signal, for causing the switching element to be conductive, through a resistor having a comparatively large resistance value. Thus, it is possible to limit the discharge current flowing at the time of sustain discharge, and display an image whose brightness is suppressed without deteriorating the gray scale.

Moreover, a plasma display apparatus of the present invention includes: a plasma display panel having a first substrate provided with a plurality of scan electrodes and sustain electrodes which are disposed in parallel with each other so as to constitute pairs of display electrodes and a second substrate which is disposed so as to face the first substrate with a discharge space formed therebetween and is provided with a plurality of data electrodes intersecting with the pairs of display electrodes, the discharge space between the pairs of display electrodes and the data electrodes constituting a discharge cell; and any one of the above-described plasma display panel driving circuits. In accordance with this construction, it is possible to construct a plasma display apparatus in which a power source potential or a ground potential is applied while switching between at least two switching elements whose turn-on times are different from each other. For example, by applying the power source potential by the switching element whose turn-on time is comparatively long, it is possible to limit the discharge current flowing at the time of sustain discharge, and display an image whose brightness is suppressed without deteriorating the gray scale.

The above object, other objects, features and advantages of the present invention will become apparent to those skilled in the art from the following detailed description of preferred embodiments with reference to the accompanying drawings.

### EFFECTS OF THE INVENTION

The present invention can provide a PDP driving circuit and a plasma display apparatus, the PDP driving circuit including an electric power recovering circuit which recovers electric power by the LC resonance, the PDP driving circuit and the plasma display apparatus being capable of displaying an image whose brightness is suppressed without deteriorating the gray scale by controlling discharge currents flowing in a discharge path at the time of sustain discharge by carrying out a switching operation of applying a power source potential while changing a turn-on time.

### BRIEF DESCRIPTION OF THE DRAWINGS

FIG. 1 is a circuit diagram of a PDP driving circuit of Embodiment 1 of the present invention.

FIG. 2 is a schematic waveform diagram showing differences between operations of switching elements whose turn-on times are different from each other.

FIG. 3 is a circuit diagram showing another example of the PDP driving circuit of Embodiment 1 of the present invention.

FIG. 4 is a circuit diagram of a PDP driving circuit of Embodiment 2 of the present invention.

FIG. 5 is a circuit diagram showing another example of the PDP driving circuit of Embodiment 2 of the present invention.

FIG. 6 is a circuit diagram of a PDP driving circuit of Embodiment 3 of the present invention.

FIG. 7 is a circuit diagram showing another example of the PDP driving circuit of Embodiment 3 of the present invention.

FIG. 8 is a circuit diagram showing still another example of the PDP driving circuit of Embodiment 3 of the present invention.

FIG. 9 is a circuit diagram showing one example of a PDP driving circuit of Embodiment 4 of the present invention.

FIG. 10 is a circuit diagram showing another example of the PDP driving circuit of Embodiment 4 of the present invention.

FIG. 11 is a perspective view showing the construction of a conventional PDP.

FIG. 12 is a diagram showing the arrangement of electrodes of the PDP of FIG. 11.

FIG. 13 is a diagram showing drive voltage waveforms applied to respective electrodes of the PDP of FIG. 11.

FIG. 14 is a block diagram showing the electrical configuration of a plasma display apparatus into which the PDP of FIG. 11 is incorporated.

FIG. 15 is a circuit diagram of a scan electrode driving circuit including an electric power recovering circuit, and a sustain pulse generating circuit which includes an electric power recovering circuit and is included in a sustain electrode driving circuit.

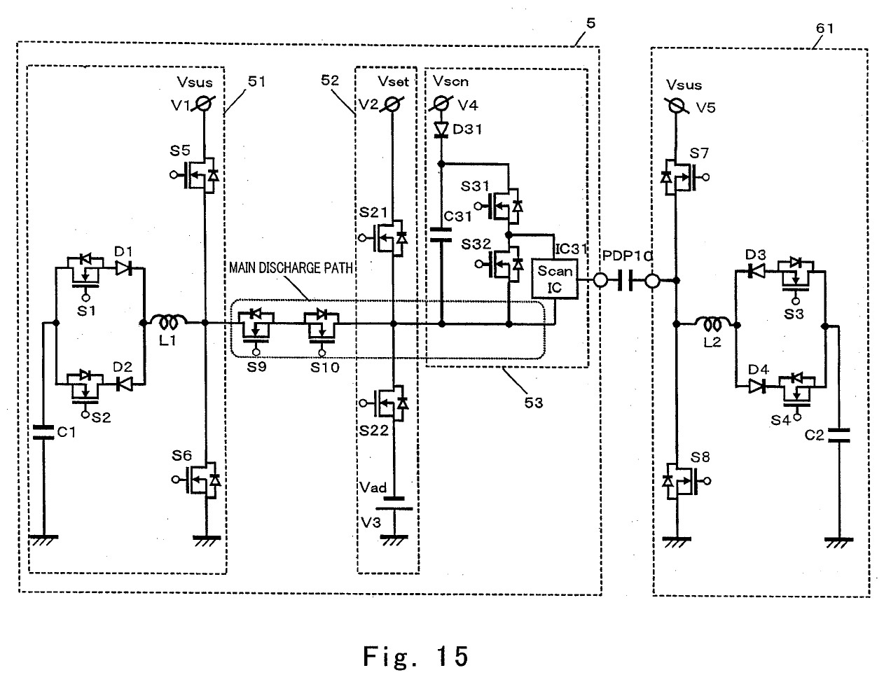

### EXPLANATION OF REFERENCE NUMBERS

1 AD converter
2 video signal processing circuit
3 sub-field processing circuit
4 data electrode driving circuit
5, 501, 504, 505, 506, 507, 508, 509 scan electrode driving circuit
6 sustain electrode driving circuit
10 plasma display panel (PDP)
20 (glass) front face plate
22 scan electrode
23 sustain electrode
24, 33 dielectric layer
25 protective layer
30 (glass) back face plate
32 data electrode
34 barrier rib
35 phosphor layer
51, 61, 62, 511, 514, 515, 516, 517, 518, 519 sustain pulse generating circuit
52 reset waveform generating circuit
53 scan pulse generating circuit
C1, C2 recovering condenser
C5₁, C5₂, C31 condenser
L1, L2, L1A, L1B coil
D1, D2, D3, D4, D10, D31 diode
S1, S2, S3, S4, S5, S5₁, S5₂, S5₃, S5₄, S5₅, S5₆, S5₇, S5₈, S6, S6₁, S6₂, S7, S7₁, S7₂, S8, S9, S10, S21, S22, S31, S32 switching element
V1, V2, V3, V4, V5 constant-voltage power source
R5₁, R5₂, R5₃, R5₄, R5₅, R5₆ resistor
IC 31 Scan IC

### BEST MODE FOR CARRYING OUT THE INVENTION

Hereinafter, preferred embodiments of the present invention will be explained with reference to the drawings.

### Embodiment 1

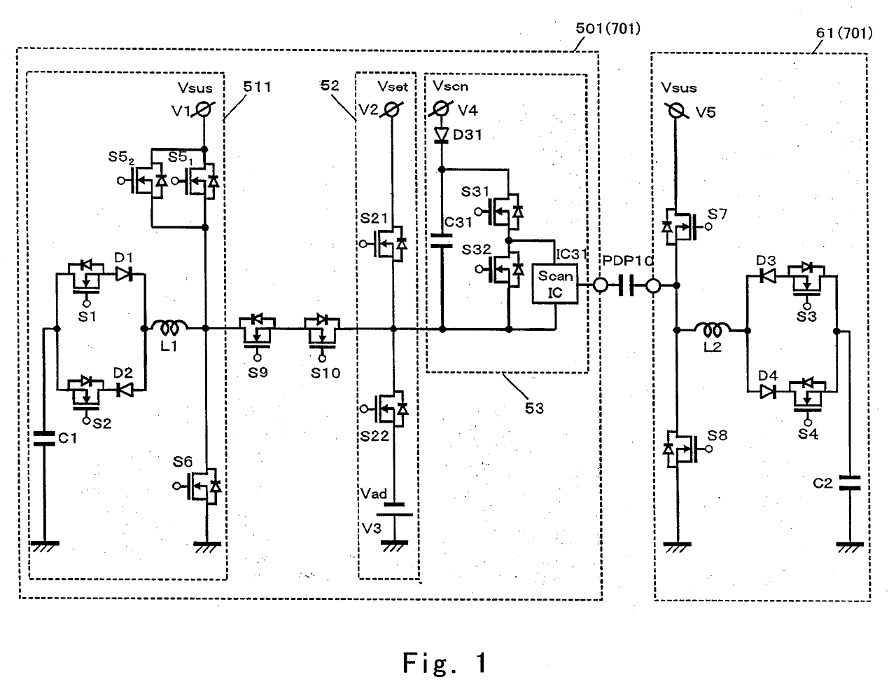

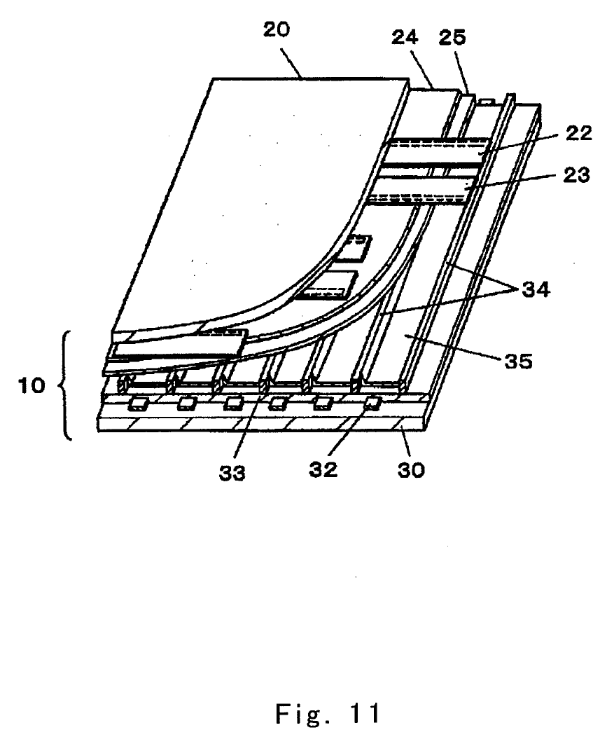

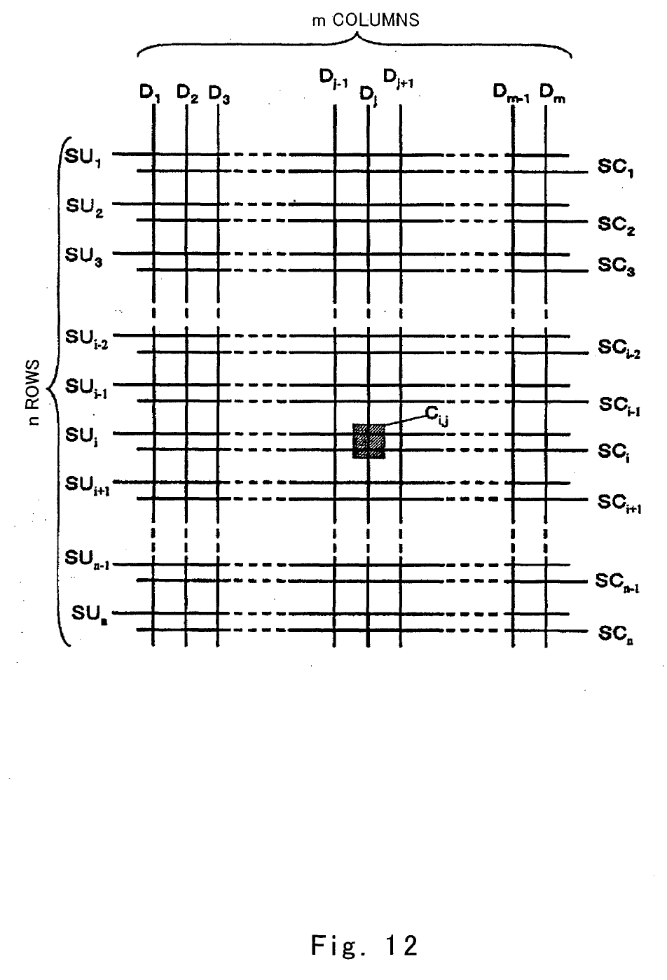

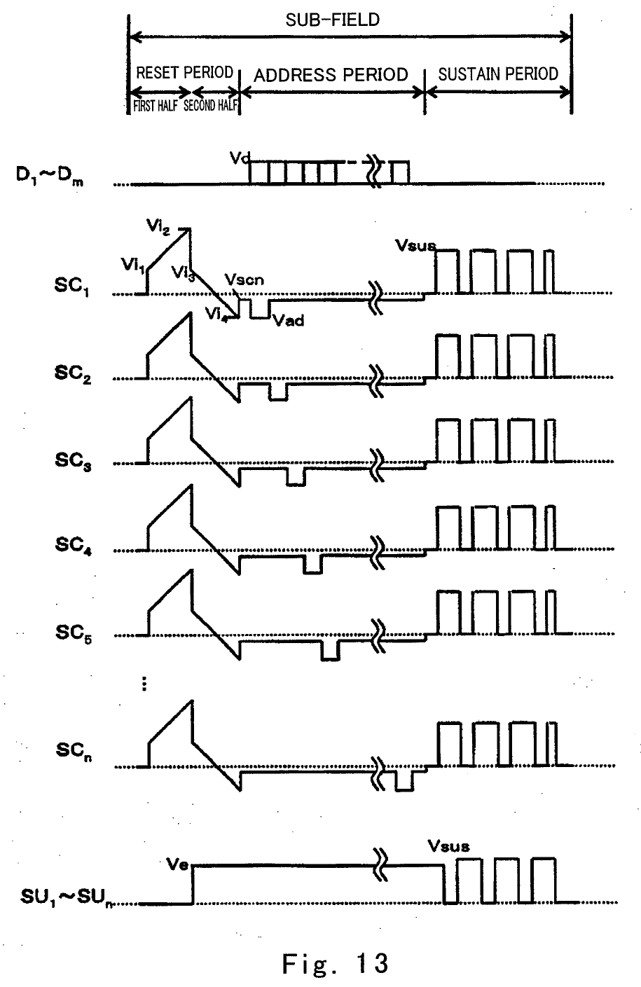

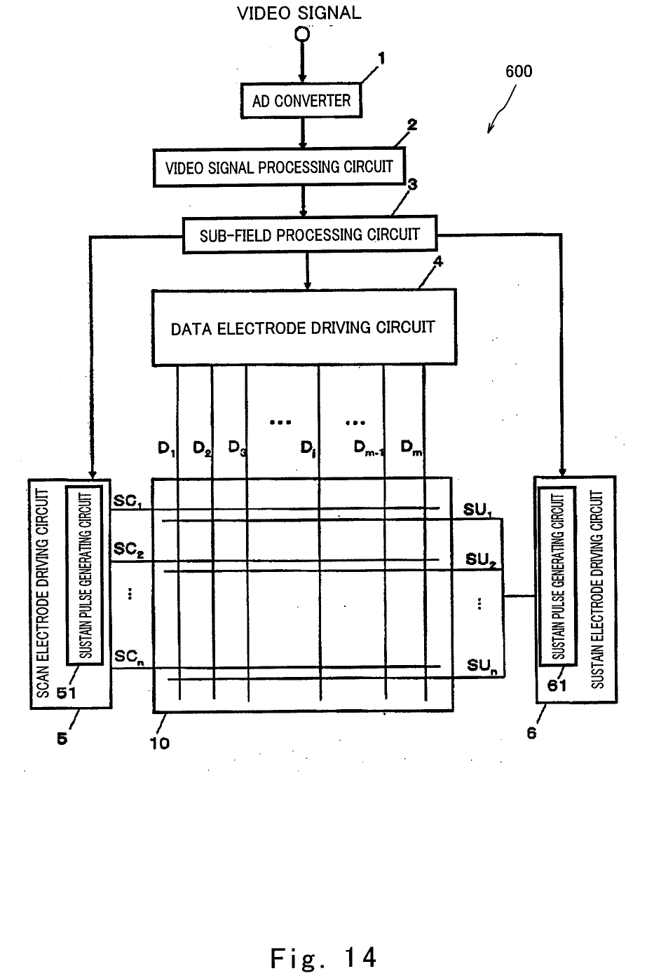

FIG. 1 is a circuit diagram of a PDP driving circuit of Embodiment 1 of the present invention. Note that the PDP 10 driven by the PDP driving circuit of the present embodiment has the same construction and electrode arrangement as the PDP 10 shown in FIGS. 11 and 12, drive voltage waveforms applied to respective electrodes of the PDP 10 by the PDP driving circuit of the present embodiment are the same as the drive voltage waveforms shown in FIG. 13, and the electrical configuration of a plasma display apparatus into which the PDP driving circuit of the present embodiment and the PDP 10 are incorporated is the same as the electrical configuration shown in FIG. 14, so that explanations regarding constructions and operations thereof are omitted here.

As shown in FIG. 1, a PDP driving circuit 701 of Embodiment 1 of the present invention includes a scan electrode driving circuit 501 having an electric power recovering circuit, and a sustain pulse generating circuit 61 having an electric power recovering circuit. The scan electrode driving circuit 501 includes a sustain pulse generating circuit 511, a reset waveform generating circuit 52, a scan pulse generating circuit 53, and a switching circuit constituted of switching elements S9 and S10.

The sustain pulse generating circuit 511 includes a the constant-voltage power source V1 of the voltage value Vsus, an electric power recovering section and a voltage clamp section. The electric power recovering section includes a coil L1, a recovering condenser C1, switching elements S1 and S2 and back flow preventing diodes D1 and D2. The voltage clamp section includes a power source clamp switch and a ground clamp switch. The power source clamp switch is constituted of switching elements S5₁ and S5₂ connected to each other in parallel, and body diodes thereof are disposed in such a direction that current flowing from the constant-voltage power source V1 is cut off. The ground clamp switch is constituted of a switching element S6, and a body diode thereof is provided in such a direction that current flowing to the GND is cut off.

The switching elements S5₁ and S5₂ are different from each other in a turn-on time that is a time from when a signal for starting conduction is applied to when the conduction is actually started. The switching element S5₁ is constituted of a switching element whose turn-on time is comparatively short (about 10 nsec for example) whereas the switching element S5₂ is constituted of a switching element whose turn-on time is comparatively long (about 100 nsec for example). The on/off (switching) control of the switching elements S5₁ and S5₂ can be carried out independently. Conditions when the electric power is supplied from the constant-voltage power source V1 to the scan electrodes SC₁ to SCₙ can be changed between a case where the power source clamping is carried out by the switching element S5₁ whose turn-on time is comparatively short and a case where the power source clamping is carried out by the switching element S5₂ whose turn-on time is comparatively long. Details thereof will be explained later.

The sustain pulse generating circuit 511 switches between the electric power recovering section and the voltage clamp section by switching of the switching elements S1, S2, S5₁, S5₂ and S6, so as to generate the sustain pulse to be applied to the scan electrodes SC₁ to SCₙ. The electric power recovering section uses the coil L1 that is an inductance element to cause the LC resonance of the capacitive load (capacitive load generated in the scan electrodes SC₁ to SCₙ of FIG. 12) of the PDP 10 and an inductance of the coil L1. Thus, the electric power recovering section recovers and supplies the electric power. The voltage clamp section supplies the electric power from the constant-voltage power source V1 of the voltage value Vsus through the switching element S5₁ or S5₂ to the scan electrodes SC₁ to SCₙ so as to clamp the scan electrodes SC₁ to SCₙ to the voltage value Vsus and clamp the scan electrodes SC₁ to SCₙ to the ground potential through the switching element S6. Thus, the voltage clamp section drives the scan electrodes SC₁ to SCₙ.

The reset waveform generating circuit 52 includes switching elements S21 and S22 constituted of generally known elements such as MOSFETs which carry out the switching operation, a constant-voltage power source V2 of a voltage value Vset that is higher in potential than the constant-voltage power source V1, and a constant-voltage power source V3 of a negative voltage value Vad. The reset waveform generating circuit 52 supplies the electric power from the constant-voltage power source V2 through the switching element S21 to the scan electrodes SC₁ to SCₙ, and supplies the electric power of the negative potential from the constant-voltage power source V3 through the switching element S22 to the scan electrodes SC₁ to SCₙ, so as to generate the reset waveform. Moreover, the switching element S21 is disposed in such a direction that its body diode cuts off the current flowing from the constant-voltage power source V2 to the main discharge path, and the switching element S22 is disposed in such a direction that its body diode cuts off the current flowing from the main discharge path to the constant-voltage power source V3.

The reset waveform generating circuit 52 generates, in the first half of the reset period, a ramp waveform moderately rising from the voltage Vᵢ₁ that is not more than the discharge start voltage with respect to the data electrodes D₁ to Dₘ to the voltage Vᵢ₂ that exceeds the discharge start voltage, that is, the voltage value Vset, and generates, in the second half of the reset period, a ramp waveform moderately falling from the voltage Vᵢ₃ that is not more than the discharge start voltage with respect to the sustain electrodes SU₁ to SUₙ to the voltage Vᵢ₄ that exceeds the discharge start voltage, that is, the voltage value Vad, so as to apply those waveforms to the scan electrodes SC₁ to SCₙ.

The scan pulse generating circuit 53 includes switching elements S31 and S32 constituted of generally known elements such as MOSFETs which carry out the switching operation, a constant-voltage power source V4 of a voltage value Vscn, a back flow preventing diode D31 which prevents current from flowing into the constant-voltage power source V4, a condenser C31, and an IC 31 which carries out the switching operation. The scan pulse generating circuit 53 generates the negative scan pulse in the address period and sequentially applies the negative pulse to the scan electrodes SC₁ to SCₙ.

The sustain pulse generating circuit 61 causes the LC resonance of the capacitive load (capacitive load generated in the sustain electrodes SU₁ to SUₙ of FIG. 12) of the PDP 10 and the inductance of the coil L2 by the same operations as the sustain pulse generating circuit 511 so as to recover and supply the electric power to drive the sustain electrodes SU₁ to SUₙ.

In order to electrically isolate the sustain pulse generating circuit 511 from the reset waveform generating circuit 52, the switching circuit constituted of the switching elements S9 and S10 connected to each other in series is disposed on the main discharge path extending between the sustain pulse generating circuit 511 and the reset waveform generating circuit 52, the switching element S9 being disposed in such a direction that its body diode cuts off the current flowing from the sustain pulse generating circuit 511 to the reset waveform generating circuit 52, the switching element S10 being disposed in such a direction that its body diode cuts off the current flowing from the reset waveform generating circuit 52 to the sustain pulse generating circuit 511. With this, in a case where the switching element S9 and the switching element S10 are turned off at the same time, both the current flowing from the sustain pulse generating circuit 511 to the reset waveform generating circuit 52 and the current flowing from the reset waveform generating circuit 52 to the sustain pulse generating circuit 511 can be cut off. Thus, the sustain pulse generating circuit 511 can be electrically isolated from the reset waveform generating circuit 52.

The switching elements S1, S2, S5₁, S5₂, S6, S9, S10, S21, S22, S31 and S32 and the IC 31 are switched based on the sub-field control signal generated in the sub-field processing circuit 3.

Next, explained is a reason why the power source clamp switch in the sustain pulse generating circuit 511 in Embodiment 1 of the present invention is constructed by connecting in parallel the switching elements S5₁ and S5₂ whose turn-on times are different from each other. The present inventor has found through experiments that there is a link between the turn-on time of the switching element at the time of the power source clamping and the emitted light brightness in the sustain discharge.

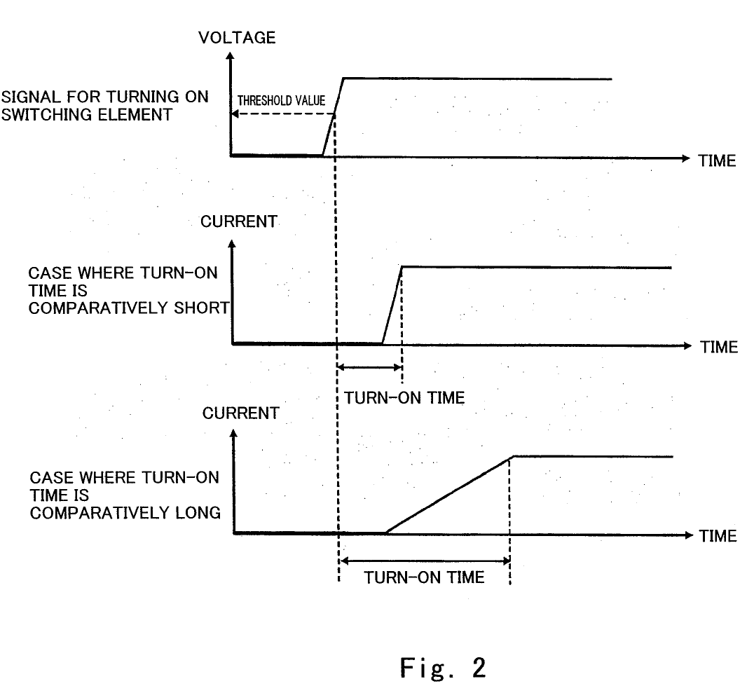

FIG. 2 is a schematic waveform diagram showing differences between operations of the switching elements whose turn-on times are different from each other. As shown in FIG. 2, a time from when a signal (hereinafter abbreviated as “ON signal”) for turning on the switching element based on the sub-field control signal generated in the sub-field processing circuit 3 is applied to the switching element to when the switching element allows the current to flow therethrough is different among the switching elements depending on the characteristics of each switching element. In the present description, a period from when the ON signal exceeds a threshold value (voltage at the intersection of the dotted line of FIG. 2 and the voltage rising line of FIG. 2) of an operating voltage until when the current flowing through the switching element reaches 90% of a steady state denotes the turn-on time. In the case of comparing the switching element whose turn-on time is comparatively short and the switching element whose turn-on time is comparatively long, there are differences therebetween shown in FIG. 2. For example, in accordance with the switching element whose turn-on time is comparatively long shown at a lower position of FIG. 2 compared to the switching element whose turn-on time is comparatively short shown at a middle position of FIG. 2, the time until when the current flowing through the switching element reaches the steady state is longer, and in addition, the increase ratio of the current flowing through the switching element is comparatively low, and the current increases comparatively moderately and then reaches the steady state.

To be specific, in the case of carrying out the power source clamping by the switching element whose turn-on time is comparatively long, the increase ratio of the current supplied from the constant-voltage power source V1 to the scan electrodes SC₁ to SCₙ is low compared to the case of carrying out the power source clamping by the switching element whose turn-on time is comparatively short. Therefore, the discharge current is temporarily limited at the time of the rising of the sustain pulse. Thus, the sustain discharge weakens, so that the emitted light brightness is suppressed.

In Embodiment 1 of the present invention, the power source clamp switch of the sustain pulse generating circuit 511 is constructed such that the switching element S5₁ whose turn-on time is comparatively short and the switching element S5₂ whose turn-on time is comparatively long are connected to each other in parallel and the on/off control of the switching elements S5₁ and S5₂ can be carried out independently. In the case of driving the scan electrodes SC₁ to SCₙ by the sustain pulse generating circuit 511 in the sustain period, when displaying a normal image, the power source clamping is carried out by the switching element S5₁ whose turn-on time is comparatively short to generate normal sustain discharge, and when displaying an image whose brightness is suppressed, the power source clamping is carried out by the switching element S5₂ whose turn-on time is comparatively long to generate weak sustain discharge.

Thus, it is possible to display, by the above switching, the image whose brightness is normal and the image whose emitted light brightness is decreased, that is, whose peak brightness is suppressed.

In accordance with the switching of the brightness in Embodiment 1 of the present invention, unlike the brightness control by the signal processing, such as the contrast control, the peak brightness is suppressed by decreasing the emitted light brightness in the discharge cell. Therefore, it is possible to display images without deteriorating the gray scale.

As above, in accordance with Embodiment 1 of the present invention, the power source clamp switch in the sustain pulse generating circuit 511 is constructed by connecting the switching element S5₁ whose turn-on time is comparatively short and the switching element S5₂ whose turn-on time is comparatively long in parallel. Therefore, the normal bright image can be displayed by the power source clamping by the switching element S5₁ whose turn-on time is comparatively short, and the image whose brightness is suppressed can be displayed by the power source clamping by the switching element S5₂ whose turn-on time is comparatively long. With this, it is possible to display images whose brightness is suppressed without deteriorating the gray scale. For example, in the case of seeing a movie including many dark scenes or in the case of seeing the plasma display apparatus in a dark circumstance, it is possible to display images whose brightness is suppressed and black is sharp without deteriorating the gray scale.

Note that in FIG. 1, each of the switching elements S5₁, S5₂, etc. is shown as a single switching element for facilitating visualization of the drawing. However, it is desirable that each switching element be constituted of elements, the number of which is set to the most suitable number determined depending on, for example, the rating of the switching element used and the maximum current flowing at the time of driving.

Explained in Embodiment 1 of the present invention is that the power source clamp switch is constructed using two switching elements whose turn-on times are different from each other, and image display by the normal emitted light brightness and image display by the suppressed emitted light brightness are switched. However, the present embodiment is not limited to this. The power source clamp switch may be constructed using three or more switching elements whose turn-on times are different from one another, and may be able to finely switch the degree of suppression of the emitted light brightness.

Explained in Embodiment 1 of the present invention is an example in which the power source clamp switch in the sustain pulse generating circuit 511 of the scan electrode driving circuit 501 is constructed by connecting in parallel the switching element S5₁ whose turn-on time is comparatively short and the switching element S5₂ whose turn-on time is comparatively long. However, the power source clamp switch in the sustain pulse generating circuit 61 of the sustain electrode driving circuit 6 may be constructed in the same manner.

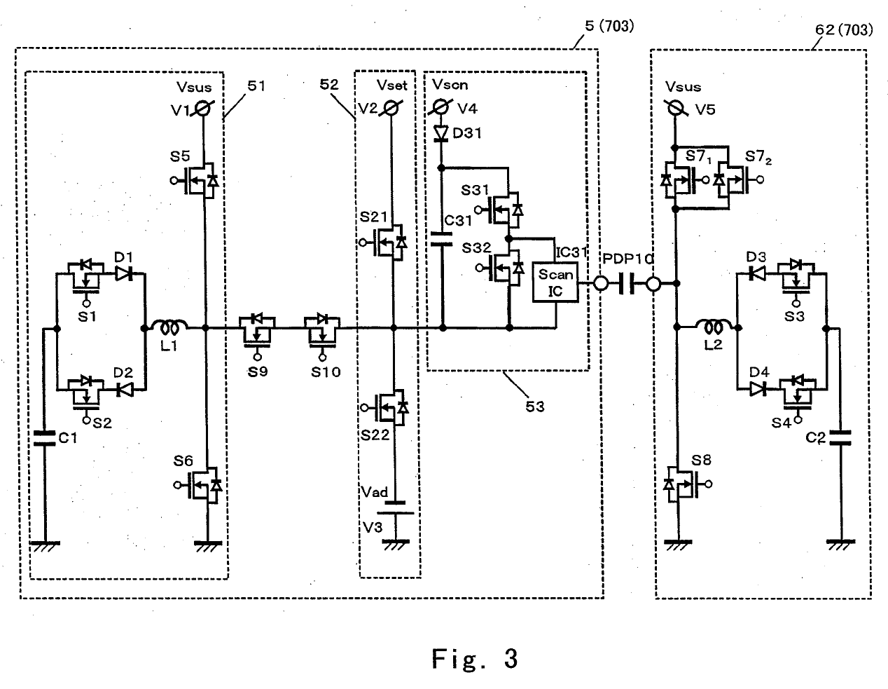

FIG. 3 is a circuit diagram showing another example of the PDP driving circuit of Embodiment 1 of the present invention. A PDP driving circuit 703 shown in FIG. 3 includes the scan electrode driving circuit 5 and a sustain pulse generating circuit 62. The sustain pulse generating circuit 62 includes the constant-voltage power source V5 of the voltage value Vsus, the electric power recovering section and the voltage clamp section. The electric power recovering section includes the coil L2, the recovering condenser C2, the switching elements S3 and S4 and the back flow preventing diodes D3 and D4. The voltage clamp section includes a power source clamp switch constructed by connecting in parallel the switching element S7₁ whose turn-on time is comparatively short and the switching element S7₂ whose turn-on time is comparatively long, and a ground clamp switch constituted of a switching element S8.

As with the PDP driving circuit 701 shown in FIG. 1, normal bright images can be displayed in the case of carrying out the power source clamping by the switching element S7₁ whose turn-on time is comparatively short, and images whose emitted light brightness is lowered and peak brightness is suppressed can be displayed in the case of carrying out the power source clamping by the switching element S7₂ whose turn-on time is comparatively long. Moreover, it is possible to use the combination of the construction shown in FIG. 1 and the construction shown in FIG. 2. In such a case, it is possible to display images whose brightness is further suppressed and black is sharp without deteriorating the gray scale.

In Embodiment 1 of the present invention, the MOSFETs are used as the switching elements in FIGS. 1 and 3. However, the present embodiment does not limit the type of the switching element. Any construction of the switching element may be used as long as the construction can switch the emitted light brightness in the sustain discharge by switching of the turn-on time. Examples are a construction using a generally known MOSFET made of silicone (Si), a construction using a MOSFET made of a generally known silicone carbide (SiC) or gallium nitride (GaN) characterized in that the current loss is low, and a construction obtained by combining a MOSFET made of Si and a MOSFET made of SiC or GaN. Especially, the MOSFET made of SiC or GaN has a comparatively short (about 10 nsec for example) turn-on time. Therefore, by combining such MOSFET and the MOSFET made of Si whose turn-on time is comparatively long (about 100 nsec for example), it is possible to easily realize the combination of the switching elements whose turn-on times are different from each other.

### Embodiment 2

Explained in Embodiment 1 of the present invention is an example in which as shown in FIG. 1, the power source clamp switch in the sustain pulse generating circuit 511 is constructed by connecting in parallel the switching element S5, whose turn-on time is comparatively short and the switching element S5₂ whose turn-on time is comparatively long. However, the switching of the turn-on time of the switching elements can be carried out by, for example, the construction using the switching elements having the same characteristics. Explained in Embodiment 2 of the present invention is an example in which the power source clamp switch is constructed by using the switching elements having the same characteristics.

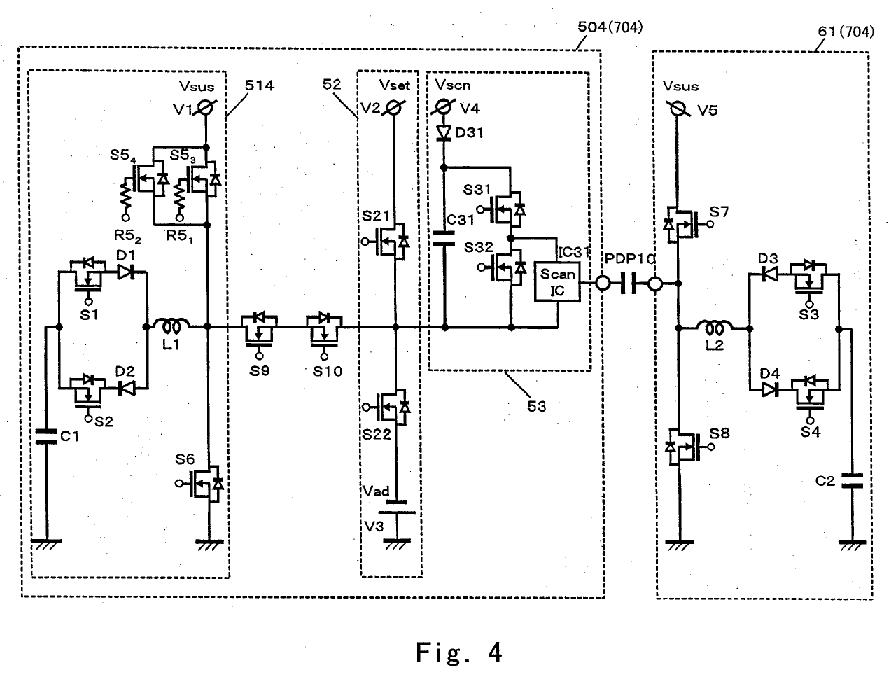

FIG. 4 is a circuit diagram of a PDP driving circuit of Embodiment 2 of the present invention. A major difference between a PDP driving circuit 704 shown in FIG. 4 and the PDP driving circuit 701 shown in FIG. 1 in Embodiment 1 is the construction of the power source clamp switch in the voltage clamp section. Therefore, different portions of the construction of the power source clamp switch will be mainly explained.

The PDP driving circuit 704 shown in FIG. 4 includes a scan electrode driving circuit 504 having an electric power recovering circuit, and the sustain pulse generating circuit 61 having an electric power recovering circuit. The scan electrode driving circuit 504 includes a sustain pulse generating circuit 514, the reset waveform generating circuit 52, the scan pulse generating circuit 53, and the switching circuit constituted of the switching elements S9 and S10.

The sustain pulse generating circuit 514 includes the constant-voltage power source V1 of the voltage value Vsus, the electric power recovering section and the voltage clamp section. The voltage clamp section includes a power source clamp switch constituted of switching elements S5₃ and S5₄ connected to each other in parallel, and a ground clamp switch constituted of the switching element S6.

The switching elements S5₃ and S5₄ constituting the power source clamp switch have substantially the same characteristics, and the turn-on times of the switching elements are substantially the same as each other. However, a resistor R5₁ is connected to a gate of the switching element S5₃, and a resistor R5₂ is connected to a gate of the switching element S5₄. Moreover, the ON signal is applied to the switching elements S5₃ and S5₄ through the resistors R5₁ and R5₂, respectively. To be specific, by setting the resistance values of the external resistors R5₁ and R5₂ to be different from each other, the apparent turn-on times of the switching element S5₃ and the switching element S5₄ become different from each other. The resistance value of the resistor R5₂ is larger than the resistance value of the resistor R5₁. Therefore, the apparent turn-on time of the switching element S5₄ is longer than that of the switching element S5₃.

As with the PDP driving circuit 701 shown in FIG. 1, the normal bright image can be displayed in the case of carrying out the power source clamping by the switching element S5₃ whose apparent turn-on time is short, and the image whose brightness is suppressed can be displayed in the case of carrying out the power source clamping by the switching element S5₄ whose apparent turn-on time is long. With this, the emitted light brightness can be lowered by generating the sustain discharge whose discharge current is limited. For example, in the case of seeing a movie including many dark scenes or in the case of seeing the plasma display apparatus in a dark circumstance, it is possible to display images whose brightness is suppressed and black is sharp without deteriorating the gray scale.

As above, in accordance with Embodiment 2 of the present invention, the power source clamp switch in the sustain pulse generating circuit 514 is constructed such that the switching elements S5₃ and S5₄ having substantially the same characteristics are connected to each other in parallel, the resistor R5₁ whose resistance value is comparatively small is connected to the gate of the switching element S5₃, and the resistor R5₂ whose resistance value is comparatively large is connected to the switching element S5₄. With this, the emitted light brightness can be lowered by generating the sustain discharge whose discharge current is limited by setting the apparent turn-on time of the switching element S5₄ to be longer than that of the switching element S5₃.

Explained in Embodiment 2 of the present invention is an example in which the turn-on times are substantially differed by different resistance values of the resistors connected to the gates of the switching elements S5₃ and S5₄ of the power source clamp switch in the sustain pulse generating circuit 514 of the scan electrode driving circuit 504. However, the turn-on times can be substantially differed by the other circuit.

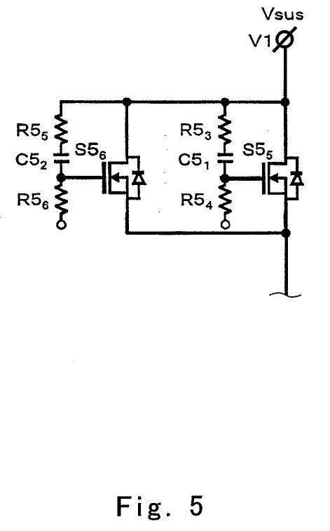

FIG. 5 is a circuit diagram showing another example of the voltage clamp section of Embodiment 2 of the present invention. The voltage clamp section shown by the circuit diagram of FIG. 5 can be replaced with the voltage clamp section constituted of the switching elements S5₃ and S5₄ in the PDP driving circuit 704 of FIG. 4. The switching elements S5₅ and S5₆ constituting the power source clamp switch have substantially the same characteristics, and the turn-on times of the switching elements are substantially the same as each other. Note that a circuit in which a resistor R5₃ and a condenser C5₁ are connected to each other in series is connected in parallel between the gate and drain of the switching element S5₅, and a resistor R5₄ is connected to the gate of the switching element S5₅. To be specific, a gate driving circuit which causes the switching element S5₅ to be conductive (on) or to be cut off (off) is constituted of a combination of the resistor R5₃, the resistor R5₄ and the condenser C5₁. Similarly, a circuit in which a resistor R5₅ and a condenser C5₂ are connected to each other in series is connected in parallel between the gate and drain of the switching element S5₆, and a resistor R5₆ is connected to the gate of the switching element S5₆. To be specific, a gate driving circuit which causes the switching element S5₆ to be conductive (on) or to be cut off (off) is constituted of a combination of the resistor R5₅, the resistor R5₆ and the condenser C5₂.

To be specific, by setting the resistance values of the external resistors R5₃, R5₄, R5₅ and R5₆ to be different from one another and setting the capacitance values of the external condensers C5₁ and C5₂ to be different from each other, the apparent turn-on times of the switching elements S5₃ and S5₄ become different from each other. This is preferable since the variable range of the turn-on time can be made wider than that of the construction in which the apparent turn-on times are differed by the difference between the resistance values of the resistor R5₁ and the resistor R5₂ shown in FIG. 4.

The ON signal is applied to the switching elements S5₅ and S5₆ through the resistors R5₅ and R5₆, respectively. The capacitance value of the condenser C5₂ is larger than that of the condenser C5₁. Therefore, the apparent turn-on time of the switching element S5₆ is longer than that of the switching element S5₅.

As with the PDP driving circuit 701 shown in FIG. 1, the normal bright image can be displayed in the case of carrying out the power source clamping by the switching element S5₅ whose apparent turn-on time is short, and the image whose brightness is suppressed can be displayed in the case of carrying out the power source clamping by the switching element S5₆ whose apparent turn-on time is long. With this, the emitted light brightness can be lowered by generating the sustain discharge whose discharge current is limited. For example, in the case of seeing a movie including many dark scenes or in the case of seeing the plasma display apparatus in a dark circumstance, it is possible to display images whose brightness is suppressed and black is sharp without deteriorating the gray scale.

As above, the apparent turn-on times can be differed by constructing the voltage clamp section in which the circuit including at least the condenser is connected between the drain and source of each of the switching elements, and the capacitances of the condensers are set to be different from each other. In the case of constructing the voltage clamp section in which the circuit including the condenser is connected between the drain and the source, the other circuit part(s) may be added thereto, and the construction is not limited to the construction of FIG. 5 in Embodiment 2.

The capacitance of each of the condensers C5₁ and C5₂ is about 1,000 pF at most, and preferably 470 pF or less. The resistance value of each of the resistors R5₁ to R5₆ is about 100Ω at most, and preferably 47Ω or less.

Note that in FIGS. 4 and 5, each of the switching elements S5₃, S5₄, S5₅ and S5₆ is shown as a single switching element for facilitating visualization of the drawing. However, it is desirable that each switching element be constituted of elements, the number of which is set to the most suitable number determined depending on, for example, the rating of the switching element used and the maximum current flowing at the time of driving.

Explained in Embodiment 2 of the present invention is an example in which the power source clamp switch is constructed using two switching elements. However, the present embodiment is not limited to this. The power source clamp switch may be constructed by using three or more switching elements, the apparent turn-on times may be differed by connecting the resistors whose resistance values are different from one another to the gates, respectively, and the degree of suppression of the emitted light brightness may be able to be finely switched.

Moreover, as with the example shown in FIG. 3, it is possible to realize a construction in which the above construction is applied to the sustain pulse generating circuit 62 connected to the sustain electrodes SU₁ to SU_{X}.

### Embodiment 3

Explained in Embodiment 1 of the present invention is an example in which as shown in FIG. 1, the power source clamp switch in the sustain pulse generating circuit 511 is constructed by combining a plurality of MOSFETs whose turn-on times are different from one another. The switching elements whose turn-on times are different from each other may be, for example, a MOSFET and a switching element that is different in type from the MOSFET. Explained in Embodiment 3 of the present invention is an example in which the power source clamp switch is constructed by combining the MOSFET and the switching element that is different in type from the MOSFET.

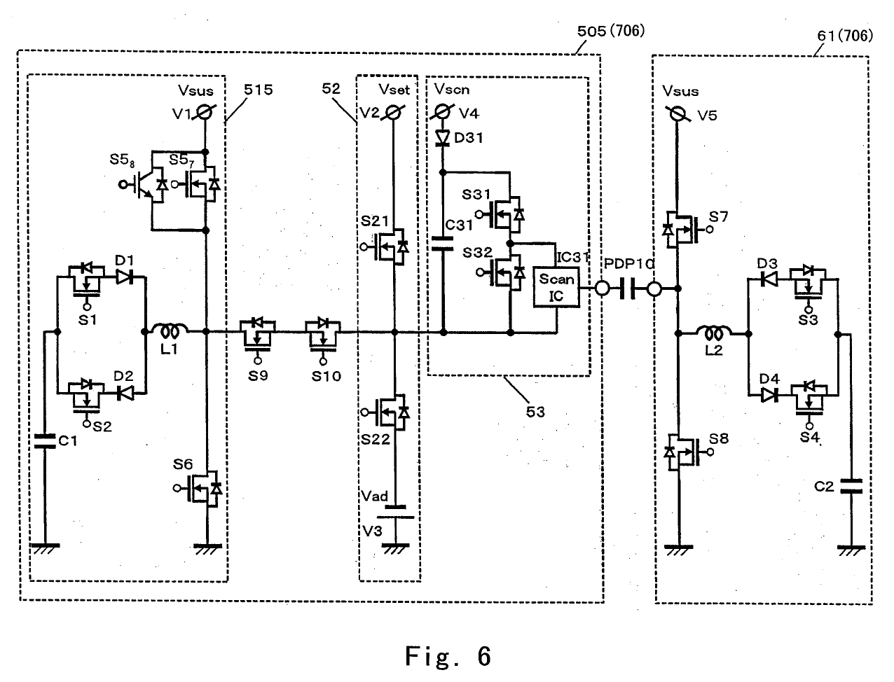

FIG. 6 is a circuit diagram of a PDP driving circuit of Embodiment 3 of the present invention. A major difference between a PDP driving circuit 706 shown in FIG. 6 and the PDP driving circuit 701 shown in FIG. 1 in Embodiment 1 is the construction of the power source clamp switch in the voltage clamp section. Therefore, major different portions of the construction of the power source clamp switch will be mainly explained.

The PDP driving circuit 706 shown in FIG. 6 includes a scan electrode driving circuit 505 having an electric power recovering circuit, and the sustain pulse generating circuit 61 having an electric power recovering circuit. The scan electrode driving circuit 505 includes a sustain pulse generating circuit 515, the reset waveform generating circuit 52, the scan pulse generating circuit 53, and the switching circuit constituted of the switching elements S9 and S10.

The sustain pulse generating circuit 515 includes the constant-voltage power source V1 of the voltage value Vsus, the electric power recovering section and the voltage clamp section. The voltage clamp section includes a power source clamp switch constituted of switching elements S5₇ and S5₈ connected to each other in parallel, and a ground clamp switch constituted of the switching element S6.

The switching element S5₇ constituting the power source clamp switch is constituted of a MOSFET, and carries out the switching operation by a comparatively short turn-on time (about 10 nsec to 100 nsec for example). Meanwhile, the switching element S5₈ is constituted of a generally known insulated-gate bipolar transistor (IGBT) characterized in that the loss is low even at the time of a high-voltage operation and its control is easy. The switching element S5₈ carries out the switching operation by a comparatively long turn-on time (about 100 nsec to 300 nsec for example). Therefore, in the case of using the switching element S5₇ constituted of the MOSFET, the power source clamping of the short turn-on time can be carried out, and in the case of using the switching element S5₈ constituted of the IGBT, the power source clamping of the long turn-on time can be carried out.

As with the PDP driving circuit 701 shown in FIG. 1, the normal bright image can be displayed in the case of carrying out the power source clamping of the comparatively short turn-on time by the switching element S5₇ constituted of the MOSFET, and the image whose brightness is suppressed can be displayed in the case of carrying out the power source clamping of the comparatively long turn-on time by the switching element S5₈ constituted of the IGBT. With this, the emitted light brightness can be lowered by generating the sustain discharge whose discharge current is limited. For example, in the case of seeing a movie including many dark scenes or in the case of seeing the plasma display apparatus in a dark circumstance, it is possible to display images whose brightness is suppressed and black is sharp without deteriorating the gray scale.

As above, in accordance with Embodiment 3 of the present invention, the power source clamp switch in the sustain pulse generating circuit 515 is constructed by connecting in parallel the switching element S5₇ constituted of the MOSFET whose turn-on time is comparatively short and the switching element S5₈ constituted of the IGBT whose turn-on time is comparatively long. With this, the power source clamping can be carried out while switching between the switching operation of the comparatively short turn-on time and the switching operation of the comparatively long turn-on time.

Note that a parasitic diode is not generated in the IGBT due to its structure. Therefore, it is desirable that the switching element S5₈ be provided with a diode equivalent to the body diode generated so as to be parasitic on the MOSFET such that the diode is disposed in the same direction as the parasitic diode of the switching element S5₇.

In FIG. 6, each of the switching elements S5₇ and S5₈ is shown as a single switching element for facilitating visualization of the drawing. However, it is desirable that each switching element be constituted of elements, the number of which is set to the most suitable number determined depending on, for example, the rating of the switching element used and the maximum current flowing at the time of driving.

Explained in Embodiment 3 of the present invention is an example in which the power source clamp switch is constituted of two switching elements. However, the present embodiment is not limited to this. For example, the power source clamp switch may be constituted of three or more switching elements, such as a combination of a plurality of MOSFETs and IGBTs whose turn-on times are different from one another, and the degree of the emitted light brightness may be finely switched.

Moreover, as with the example shown in FIG. 3, it is possible to realize a construction in which the above construction is applied to the sustain pulse generating circuit 62 connected to the sustain electrodes SU₁ to SUₙ.

Moreover, Embodiment 3 of the present invention does not limit the type of the switching element. Any combination of the switching elements may be used as long as the combination can switch the turn-on time. Examples are a combination of generally known MOSFET and IGBT made of silicone and a combination of MOSFET and IGBT made of generally known silicone carbide (SiC) or gallium nitride (GaN) characterized in that the current loss is low. Especially, the MOSFET made of SiC or GaN has a comparatively short turn-on time (about 10 nsec for example). Therefore, by combining such MOSFET and the IGBT whose turn-on time is comparatively long (about 100 nsec to 300 nsec for example), it is possible to easily realize the combination of the switching elements whose turn-on times are different from each other.

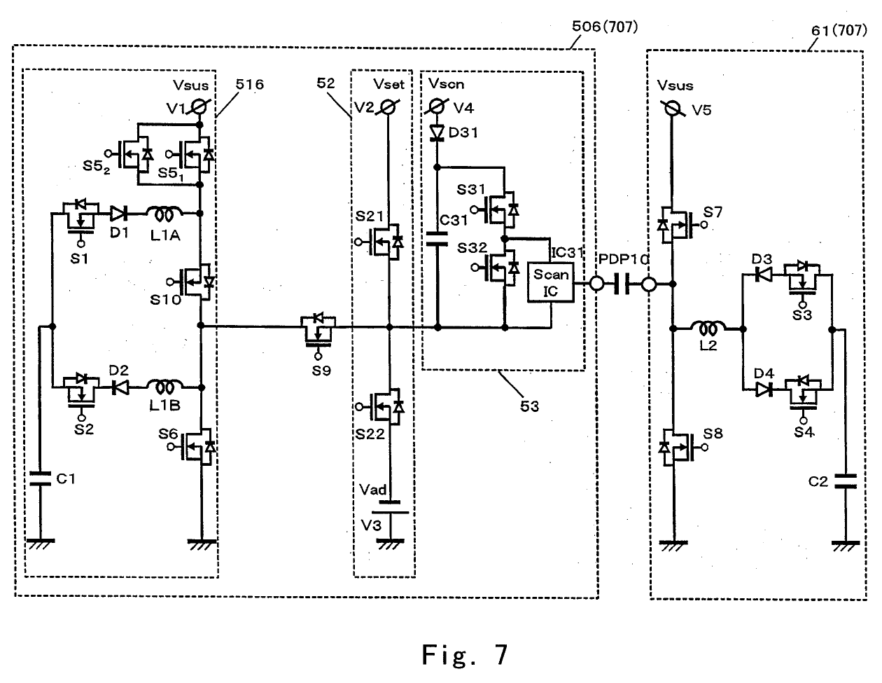

Note that in embodiments of the present invention, a construction for switching the turn-on time can be applied to other circuitry in addition to Embodiments 1 to 3 described above. FIG. 7 is a circuit diagram showing another example of the PDP driving circuit of an embodiment of the present invention. A major difference between a PDP driving circuit 707 shown in FIG. 7 and the PDP driving circuit 701 shown in FIG. 1 of Embodiment 1 is the constructions of the sustain pulse generating circuit and the switching circuit.

The PDP driving circuit 707 shown in FIG. 7 includes a scan electrode driving circuit 506 having an electric power recovering circuit and the sustain pulse generating circuit 61 having an electric power recovering circuit. The scan electrode driving circuit 506 includes a sustain pulse generating circuit 516, the reset waveform generating circuit 52, the scan pulse generating circuit 53, and a switching circuit constituted of the switching element S9.

The sustain pulse generating circuit 516 includes the constant-voltage power source V1 of the voltage value Vsus, the electric power recovering section and the voltage clamp section. The voltage clamp section includes a power source clamp switch constructed by connecting in parallel the switching element S5₁ whose turn-on time is comparatively short and the switching element S5₂ whose turn-on time is comparatively long, and a ground clamp switch constituted of the switching element S6. The electric power recovering section includes a coil L1A for use in supplying the electric power, a coil L1B for use in recovering the electric power, the recovering condenser C1, the switching elements S1 and S2, and the back flow preventing diodes D1 and D2. The LC resonance of the capacitive load of the PDP 10 and the coil L1B is caused when recovering the electric power from the capacitive load of the PDP 10 to the recovering condenser C1, and the LC resonance of the capacitive load of the PDP 10 and the coil L1A is caused when supplying the electric power from the recovering condenser C1 to the capacitive load of the PDP 10. Therefore, the sustain pulse generating circuit 516 can change the resonance frequency between when recovering the electric power and when supplying the electric power. With this, a period of recovering the electric power and a period of supplying the electric power are appropriately balanced (for example, one of these periods is set to be longer than the other), so that the recovered electric power can be reused efficiently.

Further, the sustain pulse generating circuit 516 includes the switching element S10 which is connected in series to the power source clamp switch with a contact point of the coil L1A formed therebetween and which is disposed in such a direction that its body diode cuts off the current flowing to the constant-voltage power source V1. The switching element S10 is an element obtained by moving to a power source clamping section the switching element S10 which is connected to the switching element S9 by the back-to-back connection in FIG. 1. Therefore, the switching circuit disposed on the main discharge path extending between the sustain pulse generating circuit 516 and the reset waveform generating circuit 52 is constituted of only the switching element S9 which is disposed in such a direction that its body diode cuts off the current flowing from the sustain pulse generating circuit 516 to the reset waveform generating circuit 52.

Then, the switching element S6 is disposed in such a direction that its body diode cuts off the current flowing from the main discharge path to the ground potential, and the switching element S2 is disposed in such a direction that its body diode cuts off the current flowing to the recovering condenser C1. Therefore, if the switching elements S2, S6, S9 and S10 are turned off at the same time, both the current flowing from the sustain pulse generating circuit 516 to the reset waveform generating circuit 52 and the current from the reset waveform generating circuit 52 to the sustain pulse generating circuit 516 can be cut off. Thus, the sustain pulse generating circuit 516 can be electrically isolated from the reset waveform generating circuit 52.

Also in the construction shown in FIG. 7, by carrying out the power source clamping while switching between the switching element S5₁ whose turn-on time is comparatively short and the switching element S5₂ whose turn-on time is comparatively long, the above-described effect can be obtained, that is, it is possible to switch between displaying the normal bright image and displaying the image whose brightness is suppressed without deteriorating the gray scale.

Note that in FIG. 7, the switching element S10 is shown as a single switching element for facilitating visualization of the drawing. However, it is desirable that each switching element be constituted of elements, the number of which is set to the most suitable number determined depending on, for example, the rating of the switching element used and the maximum current flowing at the time of driving.

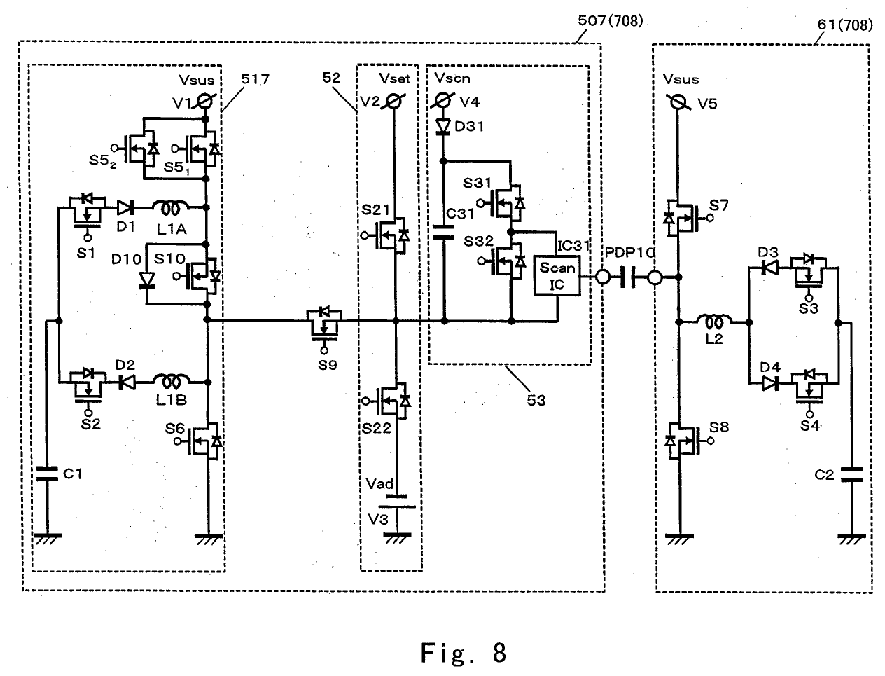

FIG. 8 is a circuit diagram showing still another example of the PDP driving circuit of an embodiment of the present invention. A PDP driving circuit 708 shown in FIG. 8 is constructed by connecting in parallel a diode D10 to the switching element S10 of the sustain pulse generating circuit 516 shown in FIG. 7. As with the body diode of the switching element S10, the diode D10 is disposed in such a direction that it cuts off the current flowing from the main discharge path to the constant-voltage power source V1 and the recovering condenser C1. Moreover, by turning off the switching element S10, the current flowing from the main discharge path to the constant-voltage power source V1 and the recovering condenser C1 can be cut off, and by turning off the switching elements S1, S5₁ and S5₂, the current flowing from the constant-voltage power source V1 and the recovering condenser C1 to the main discharge path can be cut off. Therefore, as with the PDP driving circuit 707 shown in FIG. 7, the sustain pulse generating circuit 517 can be electrically isolated from the reset waveform generating circuit 52. The diode D10 may have a larger rated value than the MOSFET. Therefore, by realizing the construction shown in FIG. 8, it is possible to construct the switching element S10, the number of elements of which is reduced (as described above, a plurality of the switching elements S10 are arranged in parallel with each other to obtain the amount of current).

The embodiment of the present invention can be applied to the construction shown in FIG. 8. By carrying out the power source clamping while switching between the switching element S5₁ whose turn-on time is comparatively short and the switching element S5₂ whose turn-on time is comparatively long, the above-described effect can be obtained, that is, it is possible to switch between displaying the normal bright image and displaying the image whose brightness is suppressed without deteriorating the gray scale.

### Embodiment 4

Explained in Embodiments 1 to 3 of the present invention is the construction in which each of the scan electrode driving circuit and the sustain electrode driving circuit includes the sustain pulse generating circuit, and the sustain discharge is generated by alternately applying the sustain pulse to the scan electrodes SC₁ to SCₙ and the sustain electrodes SU₁ to SUₙ. However, the present invention is not limited to this. For example, the combination of the switching elements whose turn-on times are different from each other as shown in Embodiments 1 to 3 of the present invention can be applied to even the circuitry which generates the sustain discharge by applying the sustain pulse to only the scan electrodes SC₁ to SCₙ. Explained in Embodiment 4 of the present invention is an example in which the combination of the switching elements whose turn-on times are different from each other is applied to the construction which generates the sustain discharge by applying the sustain pulse to the scan electrodes SC₁ to SCₙ or the sustain electrodes SU₁ to SUₙ.

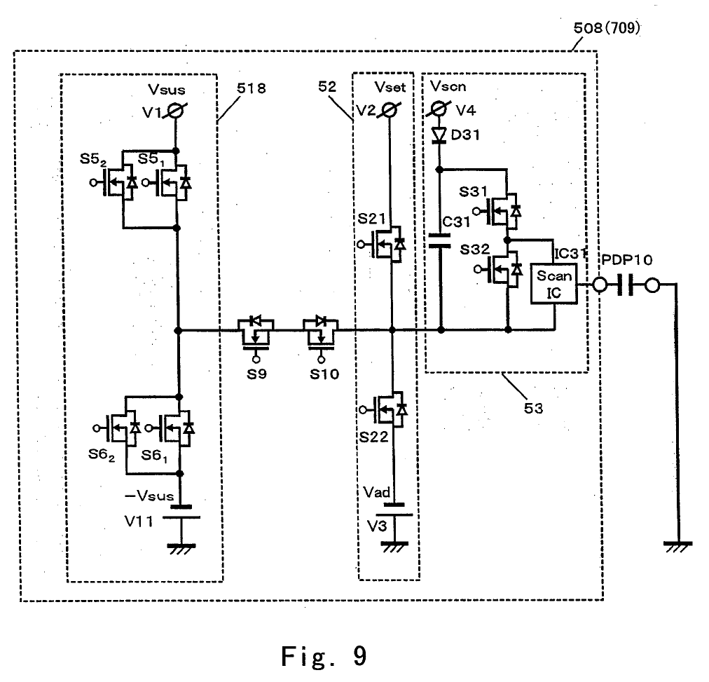

FIG. 9 is a circuit diagram showing one example of a PDP driving circuit of Embodiment 4 of the present invention. A PDP driving circuit 709 shown in FIG. 9 includes a scan electrode driving circuit 508. The scan electrode driving circuit 508 includes a sustain pulse generating circuit 518, the reset waveform generating circuit 52, the scan pulse generating circuit 53, and the switching circuit constituted of the switching elements S9 and S10. Note that the reset waveform generating circuit 52, the scan pulse generating circuit 53 and the switching circuit are constructed in the same manner as those of the PDP driving circuit 701 shown in FIG. 1, so that they carry out the same operations as those of the PDP driving circuit 701.

The sustain pulse generating circuit 518 includes the constant-voltage power source V1 of the voltage value Vsus, a constant-voltage power source V11 of a negative voltage value (−Vsus), and a voltage clamp section. The voltage clamp section includes: a clamp switch which is constructed by connecting in parallel the switching elements S5₁ and S5₂, whose body diodes are disposed in such a direction that they cut off the current flowing from the constant-voltage power source V1, and which clamps the scan electrodes SC₁ to SCₙ to the potential of the constant-voltage power source V1; and a clamp switch which is constructed by connecting in parallel the switching elements S6₁ and S6₂, whose body diodes are disposed in such a direction that they cut off the current flowing to the constant-voltage power source V11, and which clamps the scan electrodes SC₁ to SCₙ to the negative potential of the constant-voltage power source V11. Moreover, in the PDP driving circuit 709 shown in FIG. 9, the sustain electrodes SU₁ to SUₙ are connected to the ground potential.

Then, by applying to the scan electrodes SC₁ to SCₙ the sustain pulse of the amplitude from the voltage value (−Vsus) to the voltage value Vsus which is generated by the sustain pulse generating circuit 518, the potentials of the scan electrodes SC₁ to SCₙ are changed from the voltage value (−Vsus) to the voltage value Vsus or from the voltage value Vsus to the voltage value (−Vsus) to generate the sustain discharge.

The switching elements S5₁ and S5₂ are different from each other in the turn-on time. The switching element S5₁ is constituted of a switching element whose turn-on time is comparatively short (about 10 nsec for example) whereas the switching element S5₂ is constituted of a switching element whose turn-on time is comparatively long (about 100 nsec for example). The on/off control of the switching elements S5₁ and S5₂ can be carried out independently. Conditions when the electric power is supplied from the constant-voltage power source V1 to the scan electrodes SC₁ to SCₙ can be changed between a case where the clamping is carried out by the switching element S5₁ whose turn-on time is comparatively short and a case where the clamping is carried out by the switching element S5₂ whose turn-on time is comparatively long.

Also, the switching elements S6₁ and S6₂ are different from each other in the turn-on time. The switching element S6₁ is constituted of a switching element whose turn-on time is comparatively short (about 10 nsec for example) whereas the switching element S6₂ is constituted of a switching element whose turn-on time is comparatively long (about 100 nsec for example). The on/off control of the switching elements S6₁ and S6₂ can be carried out independently. As with the switching elements S5₁ and S5₂, conditions when the electric power of the negative potential is supplied from the constant-voltage power source V11 to the scan electrodes SC₁ to SCₙ can be changed between a case where the clamping is carried out by the switching element S6₁ whose turn-on time is comparatively short and a case where the clamping is carried out by the switching element S6₂ whose turn-on time is comparatively long.

For example, even in the case of the construction shown in FIG. 9 as with the PDP driving circuit 701 shown in FIG. 1, the normal bright image can be displayed in the case of carrying out the clamping by the switching element S5₁, S6₁ whose turn-on time is comparatively short, and the image whose brightness is suppressed can be displayed in the case of carrying out the clamping by the switching element S5₂, S6₂ whose turn-on time is comparatively long. With this, the emitted light brightness can be lowered by generating the sustain discharge whose discharge current is limited. For example, in the case of seeing a movie including many dark scenes or in the case of seeing the plasma display apparatus in a dark circumstance, it is possible to display images whose brightness is suppressed and black is sharp without deteriorating the gray scale.

Note that in FIG. 9, each of the switching elements S5₁, S5₂, S6₁ and S6₂ is shown as a single switching element for facilitating visualization of the drawing. However, it is desirable that each switching element be constituted of elements, the number of which is set to the most suitable number determined depending on, for example, the rating of the switching element used and the maximum current flowing at the time of driving.

Explained in Embodiment 4 of the present invention is an example in which each clamp switch is constituted of two switching elements. However, the present invention is not limited to this. The clamp switch may be constituted of three or more switching elements whose turn-on times are different from one another, and the degree of the emitted light brightness may be finely switched.

Explained in Embodiment 4 shown in FIG. 9 is an example in which the construction explained in Embodiment 1 for switching the turn-on time is applied to a different circuit. However, it is also possible to apply, to a different circuit, each of the constructions explained in Embodiments 2 and 3 for switching the turn-on time, which are, for example, the construction in which the switching elements having substantially the same characteristics are connected in parallel to each other, and the apparent turn-on time is switched by applying the ON signal to the switching elements through the resistors which are different from each other in the resistance value, the construction in which the MOSFET and the IGBT are connected in parallel to each other, and the construction in which the MOSFET made of Si and the MOSFET made of SiC are combined with each other. It is also possible to apply to a different circuit the construction in which the scan electrodes SC₁ to SCₙ is connected to the ground potential, and the sustain pulse is applied to the sustain electrodes SU₁ to SUₙ.

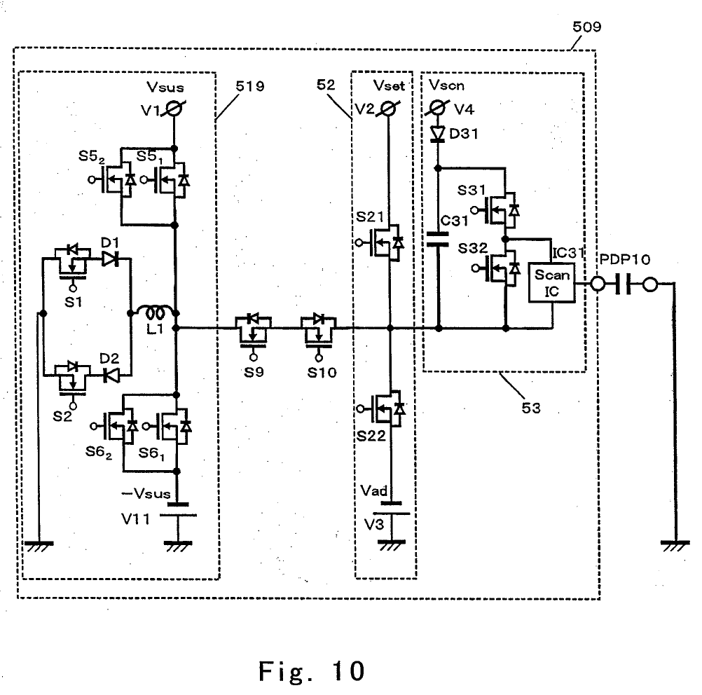

Moreover, the electric power recovering circuit constituted of the coil L1, the diodes D1 and D2, the switching elements S1 and S2 and the recovering condenser C1 shown in FIG. 1 are not shown in the sustain pulse generating circuit 518 shown in FIG. 9. However, the sustain pulse generating circuit 518 shown in FIG. 9 may include such electric power recovering circuit. FIG. 10 is a circuit diagram showing another example of the PDP driving circuit of Embodiment 4 of the present invention. A PDP driving circuit 710 shown in FIG. 10 includes a scan electrode driving circuit 509. The scan electrode driving circuit 509 includes a sustain pulse generating circuit 519, the reset waveform generating circuit 52, the scan pulse generating circuit 53, and the switching circuit constituted of the switching elements S9 and S10. Here, as shown in FIG. 10 for example, the sustain pulse generating circuit 519 may be constructed such that the electric power recovering circuit is constituted of, excluding the recovering condenser C1, the coil L1, the diodes D1 and D2 and the switching elements S1 and S2, and the drain terminal of the switching element S1 and the source terminal of the switching element S2 are directly connected to the ground potential.

Note that the relation between the turn-on time of the switching element and the emitted light brightness of the sustain discharge changes depending on the characteristics of the PDP, the characteristics of the driving circuit, the load capacitance generated in an electrode, etc. Therefore, in Embodiments 1 to 4 of the present invention, it is desirable that experiments, etc be carried out to obtain a relation between the emitted light brightness of the PDP for use in the plasma display apparatus and the turn-on time of the switching element, and the emitted light brightness and the turn-on time be set to appropriate values depending on the experiment result, the specification of the plasma display apparatus, etc.

Moreover, in an embodiment of the present invention, it is possible to use a combination of the embodiments shown in FIGS. 1, 3, 4 and 6, and it is also possible to widen the variable range of the turn-on time by such combination.

Moreover, in Embodiments 1 to 4 of the present invention, as the switching element, a MOSFET made of generally known silicone carbide (SiC) or gallium nitride (GaN) characterized in that the current loss is low may be used, and a MOSFET made of silicone and a MOSFET made of SiC may be combined with each other.

Moreover, the numerical values of the turn-on time explained in Embodiments 1 to 4 of the present invention are just examples, and the present invention is not limited to these numerical values. Any combination of the turn-on times may be used as long as the emitted light brightness in the sustain discharge can be switched.

Moreover, in Embodiments 1 to 4 of the present invention, the switching element used may be switched between in the sustain period of a certain sub-field and in the sustain period of the other sub-field. However, it is unnecessary to use the same switching element throughout one entire sustain period. For example, the turn-on time may be switched by changing the switching element between the first half and second half of one sustain period, or a switching element whose turn-on time is comparatively long may be used for a predetermined number of sustain pulses in one sustain period, and a switching element whose turn-on time is comparatively short may be used for the remaining number of sustain pulses. Thus, the switching element in the sustain period may be switched freely.

Moreover, in Embodiments 1 to 4 of the present invention, the specific circuitries of the reset waveform generating circuit 52 and the scan pulse generating circuit 53 are not limited to the constructions shown in FIG. 1. A main point of the present invention is shown in the sustain pulse generating circuit, and the other circuitries do not limit the main point of the present invention. For example, a short circuit between the drain and source of the switching element S31 of the scan pulse generating circuit 53 may be caused, and the switching elements S31 and S32 may be omitted (not shown).

From the foregoing explanation, many modifications and other embodiments of the present invention are obvious to one skilled in the art. Therefore, the foregoing explanation should be interpreted only as an example, and is provided for the purpose of teaching the best mode for carrying out the present invention to one skilled in the art. The structures and/or functional details may be substantially modified within the spirit of the present invention.

### INDUSTRIAL APPLICABILITY

In accordance with a PDP driving circuit and a plasma display apparatus according to the present invention, it is possible to provide a PDP driving circuit and a plasma display apparatus, the PDP driving circuit including an electric power recovering circuit which recovers electric power by the LC resonance, the PDP driving circuit and the plasma display apparatus being capable of displaying an image whose brightness is suppressed without deteriorating the gray scale by controlling discharge currents flowing in a discharge path at the time of sustain discharge by carrying out a switching operation at the time of a power source clamping while changing a turn-on time. Therefore, the present invention is useful as a PDP driving circuit and a plasma display apparatus.

1. A plasma display panel driving circuit which drives a plasma display panel including a plurality of scan electrodes and sustain electrodes constituting pairs of display electrodes, wherein
as switches for applying a predetermined potential to the scan electrodes and the sustain electrodes, at least two switching elements whose turn-on times are different from each other are connected to each other in parallel, and
the at least two switching elements are able to be controlled independently.

2. The plasma display panel driving circuit according to claim 1, which drives the plasma display panel by applying, to the scan electrodes and the sustain electrodes, voltages of driving waveforms different for each of periods in a sub-field including a reset period in which insides of discharge cells of the plasma display panel are charged to realize address discharge, an address period which is a period after the reset period and in which the address discharge is generated in the discharge cells to be turned on, and a sustain period which is a period after the address period and in which the discharge cells in which the address discharge is generated are turned on, the plasma display panel driving circuit comprising:
a scan electrode driving circuit connected to the scan electrodes; and
a sustain electrode driving circuit connected to the sustain electrodes, wherein:
said scan electrode driving circuit or said sustain electrode driving circuit includes a sustain pulse generating circuit which is constituted of an electric power recovering section and a clamp section to generate a sustain pulse applied to the scan electrodes or the sustain electrodes of the plasma display panel in respective sustain periods of a plurality of sub-fields constituting one field, the electric power recovering section recovering, in a recovering condenser by a LC resonance, electric power accumulated in capacitive load of the scan electrodes or the sustain electrodes of the plasma display panel and reusing the recovered electric power for driving the plasma display panel, the clamp section applying a power source potential or a ground potential to the scan electrodes or the sustain electrodes of the plasma display panel; and
as a power source clamp switch of the clamp section which applies the power source potential to the scan electrodes or the sustain electrodes, the at least two switching elements are connected to each other in parallel.

3. The plasma display panel driving circuit according to claim 2, wherein the at least two switching elements are MOSFETs.

4. The plasma display panel driving circuit according to claim 3, wherein the at least two switching elements include a MOSFET made of silicone carbide and a MOSFET made of silicone.

5. The plasma display panel driving circuit according to claim 2, wherein the at least two switching elements include a MOSFET and an IGBT.

6. The plasma display panel driving circuit according to claim 5, wherein the at least two switching elements include a MOSFET made of silicone carbide.

7. A plasma display panel driving circuit which drives a plasma display panel by applying, to a plurality of scan electrodes and sustain electrodes constituting pairs of display electrodes of the plasma display panel, voltages of driving waveforms different for each of periods in a sub-field including a reset period in which insides of discharge cells of the plasma display panel are charged to realize address discharge, an address period which is a period after the reset period and in which the address discharge is generated in the discharge cells to be turned on, and a sustain period which is a period after the address period and in which the discharge cells in which the address discharge is generated are turned on, the plasma display panel driving circuit comprising:
a scan electrode driving circuit connected to the scan electrodes; and
a sustain electrode driving circuit connected to the sustain electrodes, wherein:
said scan electrode driving circuit or said sustain electrode driving circuit includes a sustain pulse generating circuit which is constituted of an electric power recovering section and a clamp section to generate a sustain pulse applied to the scan electrodes or the sustain electrodes of the plasma display panel in respective sustain periods of a plurality of sub-fields constituting one field, the electric power recovering section recovering, in a recovering condenser by a LC resonance, electric power accumulated in capacitive load of the scan electrodes or the sustain electrodes of the plasma display panel and reusing the recovered electric power for driving the plasma display panel, the clamp section applying a power source potential or a ground potential to the scan electrodes or the sustain electrodes of the plasma display panel; and
as a power source clamp switch of the clamp section which applies the power source potential to the scan electrodes or the sustain electrodes, at least two switching elements whose turn-on times are substantially the same as each other are connected to each other in parallel, apparent turn-on times of the at least two switching elements are made different from each other by applying a signal, for causing the switching elements to be conductive, to the at least two switching elements through respective resistors of different resistance values, and the at least two switching elements is able to be controlled independently.

8. The plasma display panel driving circuit according to claim 7, further comprising a gate driving circuit which is constituted of a combination of at least one resistor and at least one condenser, corresponds to each of the at least two switching elements, and turns on and cuts off the switching elements, wherein
the apparent turn-on times of the at least two switching elements are made different from each other by setting the resistance value of the resistor of the gate driving circuit or the capacitance value of the condenser of the gate driving circuit to be different for each of the switching elements.

9. A plasma display apparatus comprising:
a plasma display panel including: a first substrate provided with a plurality of scan electrodes and sustain electrodes which are disposed in parallel with each other so as to constitute pairs of display electrodes; and a second substrate which is disposed so as to face the first substrate with a discharge space formed therebetween and is provided with a plurality of data electrodes intersecting with the pairs of display electrodes, the discharge space between the pairs of display electrodes and the data electrodes constituting a discharge cell; and
the plasma display panel driving circuit according to claim 1.
